(19) United States
(12) Patent Application Publication
(10) Pub. No.: US 2026/0205711 A1
(43) Pub. Date: Jul. 16, 2026

(54) SOLID-STATE IMAGING DEVICE AND ELECTRONIC APPARATUS

(71) Applicant: SONY SEMICONDUCTOR SOLUTIONS CORPORATION, Kanagawa (JP)

(72) Inventor: Yuhi YORIKADO, Kanagawa (JP)

(73) Assignee: SONY SEMICONDUCTOR SOLUTIONS CORPORATION, Kanagawa (JP)

(21) Appl. No.: 19/135,219

(22) PCT Filed: Nov. 17, 2023
(86) PCT No.: PCT/JP2023/041518

§ 371 Date: Jun. 3, 2025

(30) Foreign Application Priority Data
Dec. 14, 2022 (JP) 2022-199558

(51) Int. Cl. H04N 25/13; H04N 25/47; H04N 25/77

(52) U.S. Cl. CPC H04N 25/13; H04N 25/47; H04N 25/77

(57) ABSTRACT

There is provided a solid-state imaging device including a pixel array unit that includes a plurality of pixels each configured to generate charge by photoelectric conversion, in which the plurality of pixels include a plurality of event pixels each configured to generate an event signal on the basis of a luminance change of incident light, and a plurality of gradation pixels each configured to generate a luminance signal on the basis of a light amount of incident light. Each event pixel is associated with a white or cyan filter, and each gradation pixel is associated with a red, green, or blue color filter.

### CROSS REFERENCE TO RELATED APPLICATIONS

This application claims the benefit of Japanese Priority Patent Application JP 2022-199558 filed Dec. 14, 2022, the entire contents of which are incorporated herein by reference.

### TECHNICAL FIELD

The present disclosure relates to a solid-state imaging device and an electronic apparatus.

### BACKGROUND ART

A solid-state imaging device proposed in the past includes event pixels each detecting occurrence of an event on the basis of an amount of a change of charge generated from incident light entering a photodiode, and gradation pixels each outputting a pixel signal corresponding to an amount of charge generated from incident light entering a photodiode.

### CITATION LIST

### Patent Literature

PTL 1: PCT Patent Publication No. WO 2021/117350

### SUMMARY

### Technical Problem

According to the technology described above, color mixture may be caused from a predetermined gradation pixel to an adjacent gradation pixel, for example. In this case, image quality of gradation pixels may be deteriorated.

Accordingly, the present disclosure developed in consideration of the above-mentioned problems provides a solid-state imaging device capable of reducing image quality deterioration of gradation pixels.

### Solution to Problem

A solid-state imaging device according to a first aspect of the present disclosure includes a pixel array unit that includes a plurality of pixels each configured to generate charge by photoelectric conversion. The plurality of pixels include a plurality of event pixels each configured to generate an event signal on the basis of a luminance change of incident light, and a plurality of gradation pixels each configured to generate a luminance signal on the basis of a light amount of incident light. Each of color arrangements of the event pixels and the gradation pixels does not have 180-degree rotational symmetry. In this configuration, by providing the white color filter having a relatively high refractive index on each of the event pixels, the pixel array unit is capable of reducing color mixture caused by intrusion of incident light from the event pixels into the gradation pixels in comparison with a state of no color filter. Moreover, the pixel array unit having the white color filter on each of the event pixels is capable of reducing a drop of sensitivity to acquire luminance information. Furthermore, by providing the cyan color filter on each of the event pixels, reduction of color mixture caused by intrusion of incident light from the event pixels into the gradation pixels is achievable in comparison with a state of no color filter. In addition, the event pixels each including the cyan color filter achieve more reduction of color mixture of light having a long wavelength than the configuration including the white color filters.

In addition, in this first aspect, each of the event pixels and the gradation pixels further has a color filter that transmits light having a predetermined wavelength band. In this configuration, by providing the white color filter having a relatively high refractive index on each of the event pixels, the pixel array unit is capable of reducing color mixture caused by intrusion of incident light from the event pixels into the gradation pixels in comparison with a state of no color filter. Moreover, the pixel array unit having the white color filter on each of the event pixels is capable of reducing a drop of sensitivity to acquire luminance information. Furthermore, by providing the cyan color filter on each of the event pixels, reduction of color mixture caused by intrusion of incident light from the event pixels into the gradation pixels is achievable in comparison with a state of no color filter. In addition, the event pixels each including the cyan color filter achieve more reduction of color mixture of light having a long wavelength than the configuration including the white color filters.

In addition, in this first aspect, the color filters of the event pixels include either white filters or cyan filters, and the color filters of the gradation pixels include red filters, green filters, and blue filters. In this configuration, by providing the white color filter having a relatively high refractive index on each of the event pixels, the pixel array unit is capable of reducing color mixture caused by intrusion of incident light from the event pixels into the gradation pixels in comparison with a state of no color filter. Moreover, the pixel array unit having the white color filter on each of the event pixels is capable of reducing a drop of sensitivity to acquire luminance information. Furthermore, by providing the cyan color filter on each of the event pixels, reduction of color mixture caused by intrusion of incident light from the event pixels into the gradation pixels is achievable in comparison with a state of no color filter. In addition, the event pixels each including the cyan color filter achieve more reduction of color mixture of light having a long wavelength than the configuration including the white color filters. Besides, by providing a lens member on each of the event pixels located adjacent to the gradation pixels other than the blue gradation pixels, these event pixels are capable of securing a larger amount of incident light, and achieve reduction of a drop of sensitivity.

In addition, in this first aspect, the color filters of the event pixels include both white filters and cyan filters, and the color filters of the gradation pixels include red filters, green filters, and blue filters. In this configuration, the pixel array unit is capable of reducing color mixture of light having a long wavelength from the event pixels each having the cyan color filter to the adjacent blue gradation pixels. Moreover, by providing the white color filter on each of the event pixels located adjacent to the gradation pixels other than the blue gradation pixels, the pixel array unit can achieve reduction of color mixture from these event pixels into the adjacent gradation pixels while reducing a drop of sensitivity.

In addition, in this first aspect, the event pixel located adjacent to the gradation pixel having the blue color filter has the cyan color filter. In this configuration, the pixel array unit achieves reduction of color mixture of light having a long wavelength from the event pixel having the cyan color filter to the adjacent blue gradation pixel.

In addition, in this first aspect, the event pixel located adjacent to the gradation pixel having the color filter in any color other than blue has the white color filter. In this configuration, the event pixel located adjacent to the gradation pixels other than the blue gradation pixels has the white color filter. Accordingly, the pixel array unit can achieve reduction of color mixture from this event pixel into the adjacent gradation pixels while reducing a drop of sensitivity.

In addition, in this first aspect, each of the event pixels located in a central portion of the pixel array unit has the white color filter, and each of the event pixels located in a peripheral portion of the pixel array unit the cyan color filter. In this configuration, color mixture caused by intrusion of incident light from the event pixels into the gradation pixels can be reduced in comparison with a state of no color filter. Particularly, color mixture of light having a high wavelength with the blue gradation pixels in the peripheral portion of the pixel array unit can be reduced. Moreover, the event pixels in the central portion of the pixel array unit can secure a larger amount of incident light, and therefore reduce a drop of sensitivity.

In addition, in this first aspect, a ratio of the number of the event pixels to the total number of the event pixels and the gradation pixels included in the pixel array unit is 25% or smaller. In this configuration, by providing the white color filter having a relatively high refractive index on each of the event pixels, the pixel array unit is capable of reducing color mixture caused by intrusion of incident light from the event pixels into the gradation pixels in comparison with a state of no color filter. Moreover, the pixel array unit having the white color filter on each of the event pixels is capable of reducing a drop of sensitivity to acquire luminance information. Furthermore, by providing the cyan color filter on each of the event pixels, reduction of color mixture caused by intrusion of incident light from the event pixels into the gradation pixels is achievable in comparison with a state of no color filter. In addition, the event pixels each including the cyan color filter can achieve more reduction of color mixture of light having a long wavelength than the configuration including the white color filters.

In addition, in this first aspect, each of the event pixels includes an EVS pixel. In this configuration, by providing the white color filter having a relatively high refractive index on each of the event pixels, the pixel array unit is capable of reducing color mixture caused by intrusion of incident light from the event pixels into the gradation pixels in comparison with a state of no color filter. Moreover, the pixel array unit having the white color filter on each of the event pixels is capable of reducing a drop of sensitivity to acquire luminance information. Furthermore, by providing the cyan color filter on each of the event pixels, reduction of color mixture caused by intrusion of incident light from the event pixels into the gradation pixels is achievable in comparison with a state of no color filter. In addition, the event pixels each including the cyan color filter can achieve more reduction of color mixture of light having a long wavelength than the configuration including the white color filters.

In addition, in this first aspect, first light shielding walls are provided between the color filters of the plurality of pixels. In this configuration, the pixel array unit having the first light shielding walls is capable of reducing color mixture between the color filters. Moreover, the pixel array unit is capable of improving quantum efficiency.

In addition, in this first aspect, each of the first light shielding walls includes a low refractive index material structure or an air structure. In this configuration, the pixel array unit having the first light shielding walls is capable of reducing color mixture between the color filters. Moreover, each of the first light shielding walls having the air structure can have a lower refractive index than that of the low refractive index material structure. Furthermore, the pixel array unit is capable of improving quantum efficiency.

In addition, in this first aspect, each of the first light shielding walls provided between the gradation pixels and the adjacent event pixels has a thickness different from a thickness of each of the first light shielding walls provided between the gradation pixels and the adjacent gradation pixels. In this configuration, further reduction of color mixture caused by light from the event pixels to the gradation pixels each having the blue color filter is achievable. Moreover, sensitivity of the gradation pixels and the event pixels can improve.

In addition, in this first aspect, each of the first light shielding walls provided between the gradation pixels each having the blue color filter and the adjacent event pixels has a thickness larger than the thickness of each of the first light shielding walls provided between the gradation pixels and the adjacent gradation pixels. In this configuration, further reduction of color mixture caused by light from the event pixels to the gradation pixels each having the blue color filter is achievable.

In addition, in this first aspect, each of the first light shielding walls provided between the gradation pixels each having the color filter in any color other than blue and the adjacent event pixels has a thickness smaller than the thickness of each of the first light shielding walls provided between the gradation pixels and the adjacent gradation pixels. In this configuration, sensitivity of the gradation pixels and the event pixels can improve.

In addition, in this first aspect, each of the event pixels and the gradation pixels further has an on-chip lens disposed on the color filter and collecting incident light, and second light shielding walls are provided between the on-chip lenses of the plurality of pixels. In this configuration, the pixel array unit can achieve reduction of color mixture caused by incident light from the on-chip lenses into the adjacent pixels.

In addition, in this first aspect, waveguides each constituting an optical path for the incident light are provided on the color filters. In this configuration, the pixel array unit achieves reduction of color mixture into the adjacent pixels by the function of the waveguides as passages for incident light.

In addition, in this first aspect, the waveguides are provided on the white color filters or the cyan color filters. In this configuration, the pixel array unit can achieve reduction of color mixture into the adjacent pixels by the function of the waveguides as passages for incident light.

In addition, in this first aspect, each of the event pixels and the gradation pixels further includes a photodiode that is located within a semiconductor substrate below the color filter and performs photoelectric conversion, and third light shielding walls penetrating an interior of the semiconductor substrate are provided between the photodiodes of the plurality of pixels. In this configuration, the semiconductor substrate can achieve reduction of color mixture caused by light entering the photodiodes.

In addition, in this first aspect, fourth light shielding walls are provided between the plurality of pixels within an insulation film below the semiconductor substrate. In this configuration, the insulation film can achieve reduction of color mixture caused by light having entered the insulation film.

An electronic apparatus according to a second aspect of the present disclosure is an electronic apparatus including an imaging apparatus. The imaging apparatus includes a pixel array unit that includes a plurality of pixels each configured to generate charge by photoelectric conversion. The plurality of pixels include a plurality of event pixels each configured to generate an event signal on the basis of a luminance change of incident light, and a plurality of gradation pixels each configured to generate a luminance signal on the basis of a light amount of incident light. Each of color arrangements of the event pixels and the gradation pixels does not have 180-degree rotational symmetry. In this configuration, by providing the white color filter having a relatively high refractive index on each of the event pixels, the pixel array unit is capable of reducing color mixture caused by intrusion of incident light from the event pixels into the gradation pixels in comparison with a state of no color filter. Moreover, the pixel array unit having the white color filter on each of the event pixels is capable of reducing a drop of sensitivity to acquire luminance information. Furthermore, by providing the cyan color filter on each of the event pixels, reduction of color mixture caused by intrusion of incident light from the event pixels into the gradation pixels is achievable in comparison with a state of no color filter. In addition, the event pixels each including the cyan color filter achieve more reduction of color mixture of light having a long wavelength than the configuration including the white color filters.

### BRIEF DESCRIPTION OF DRAWINGS

FIG. 1 is a block diagram depicting one configuration example of an imaging apparatus according to a first embodiment.

FIG. 2 is a block diagram depicting a configuration example of a solid-state imaging device according to the first embodiment.

FIG. 3 depicts plan diagrams depicting layouts and the like of respective pixels in a pixel array unit according to the first embodiment.

FIG. 4 depict cross-sectional diagrams taken along a line a-a′ and depicting the pixel array unit and the like including gradation pixels and event pixels according to the first embodiment.

FIG. 5 is a plan diagram depicting a layout and the like of respective pixels in a pixel array unit according to a second embodiment.

FIG. 6 depict diagrams illustrating an example of transmittance of each of a white color filter and a cyan color filter.

FIG. 7 is a plan diagram depicting a layout of respective pixels in a pixel array unit according to a third embodiment.

FIG. 8 is a plan diagram depicting a layout of respective pixels in a pixel array unit according to a fourth embodiment.

FIG. 9 is a plan diagram depicting a layout of respective pixels in a pixel array unit according to a fifth embodiment.

FIG. 10 depicts plan diagrams depicting layouts of respective pixels in a pixel array unit according to sixth to eighth embodiments.

FIG. 11 depicts plan diagrams depicting layouts of respective pixels in a pixel array unit according to ninth to tenth embodiments.

FIG. 12 is a plan diagram depicting a layout and the like of respective pixels in a pixel array unit according to an eleventh embodiment.

FIG. 13 depicts examples of cross-sectional diagrams of a pixel array unit and the like according to a twelfth embodiment.

FIG. 14 is an example of a cross-sectional diagram of a pixel array unit according to a thirteenth embodiment.

FIG. 15 is an example of a cross-sectional diagram of a pixel array unit according to a fourteenth embodiment.

FIG. 16 is an example of a cross-sectional diagram of a pixel array unit according to a fifteenth embodiment.

FIG. 17 depicts examples of cross-sectional diagrams of a pixel array unit and the like according to a sixteenth embodiment.

FIG. 18 is a block diagram depicting a configuration example of a vehicle control system.

FIG. 19 is a diagram depicting an example of sensing areas.

### DESCRIPTION OF EMBODIMENTS

Embodiments according to the present disclosure will be hereinafter described with reference to the drawings.

### First Embodiment

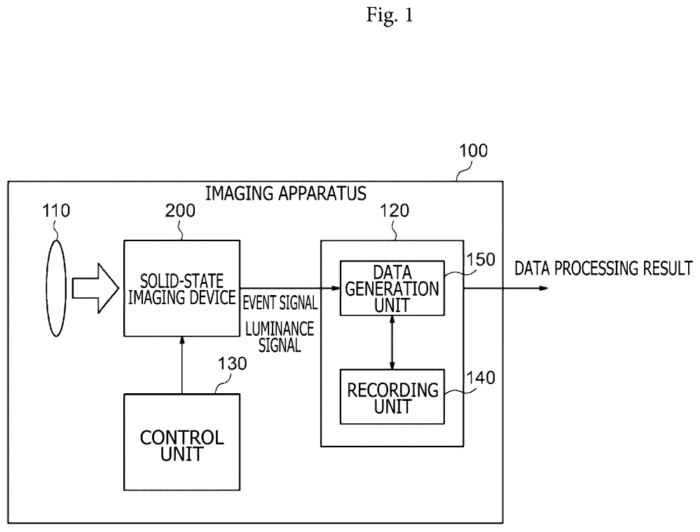

FIG. 1 is a block diagram depicting one configuration example of an imaging apparatus according to a first embodiment.

An imaging apparatus 100 in FIG. 1 includes an imaging lens 110, a solid-state imaging device 200, a control unit 130, and a data processing unit 120. Examples assumed to constitute the imaging apparatus 100 include a camera mounted on an industrial robot, and an in-vehicle camera.

The imaging lens 110 collects incident light and introduces the collected light to the solid-state imaging device 200. The solid-state imaging device 200 generates a luminance signal in a gradation level corresponding to a light amount of incident light entering through the imaging lens 110, and outputs the generated luminance signal to the data processing unit 120. Moreover, the solid-state imaging device 200 detects, as an event, a fact that a luminance change has exceeded a predetermined threshold by entrance of incident light, generates an event signal, and outputs the generated event signal to the data processing unit 120. More specifically, the solid-state imaging device 200 detects, as an event, whether or not photocurrent corresponding to luminance of incident light has changed in excess of a predetermined threshold.

The control unit 130 performs overall control of the imaging apparatus 100. For example, the control unit 130 causes the solid-state imaging device 200 to capture image data.

The data processing unit 120 includes a data generation unit 150 and a recording unit 140. The data processing unit 120 performs data processing on the basis of a signal received from the solid-state imaging device 200. Details of the data generation unit 150 and the recording unit 140 will be described below.

The data generation unit 150 performs predetermined data processing for a luminance signal received from the solid-state imaging device 200. Moreover, the data generation unit 150 performs predetermined data processing and the like using an event signal received from the solid-state imaging device 200. The data generation unit 150 outputs processed data to an external device (not depicted) as a data processing result. Alternatively, the data generation unit 150 may output the luminance signal and the event signal supplied from the solid-state imaging device 200 to the external device without change.

The recording unit 140 records data received from the solid-state imaging device 200.

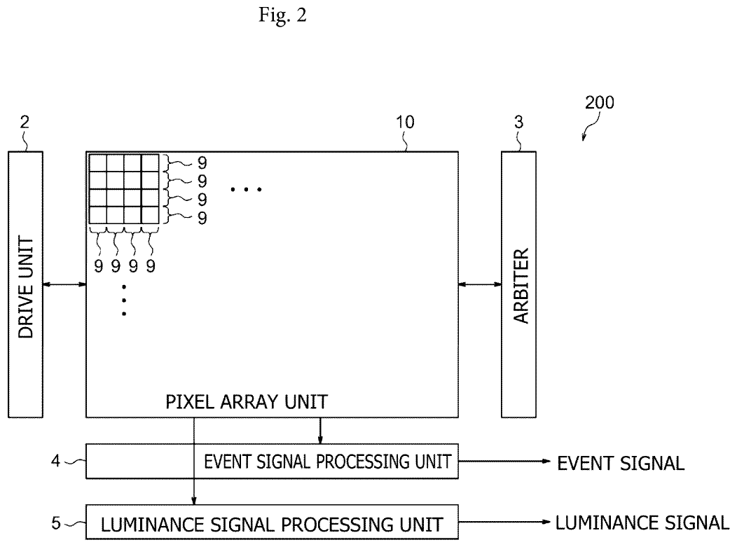

FIG. 2 is a block diagram depicting a schematic configuration example of the solid-state imaging device according to the first embodiment.

The solid-state imaging device 200 includes a pixel array unit 10, a drive unit 2, an arbiter (arbitration unit) 3, an event signal processing unit 4, and a luminance signal processing unit 5.

The pixel array unit 10 has a plurality of pixels 9 arranged in a grid shape and each generating charge by photoelectric conversion. Moreover, the pixels 9 include event pixels each detecting a luminance change of incident light as an event, and gradation pixels each generating a luminance signal indicating a gradation level corresponding to a light amount of incident light. These event pixels and gradation pixels are arranged in a layout of various types. For example, each of the event pixels is an event-based vision sensor (EVS) pixel. In addition, the respective types of layouts will be described below.

The drive unit 2 controls and drives the respective gradation pixels included in the pixel array unit 10.

The arbiter 3 arbitrates requests issued from the event pixels within the pixel array unit 10, and returns a reply indicating permission or non-permission of output of an event signal to each of the event pixels having transmitted the requests. Each of the event pixels having received the reply of permission from the arbiter 3 is allowed to output an event signal to the event signal processing unit 4. The event signal is transferred to the event signal processing unit 4 for each row. Moreover, an event signal from the event pixel included in a plurality of the event pixels in an identical row and not causing an event is discarded by the event signal processing unit 4. The arbiter 3 supplies a reset signal for resetting event detection to each of the event pixels.

The event signal processing unit 4 performs necessary processing for event signals received from the respective event pixels of the pixel array unit 10, and transmits the processed event signals to the data processing unit 120.

The luminance signal processing unit 5 performs necessary processing for luminance signals received from the respective gradation pixels of the pixel array unit 10, and transmits the processed luminance signals to the data processing unit 120.

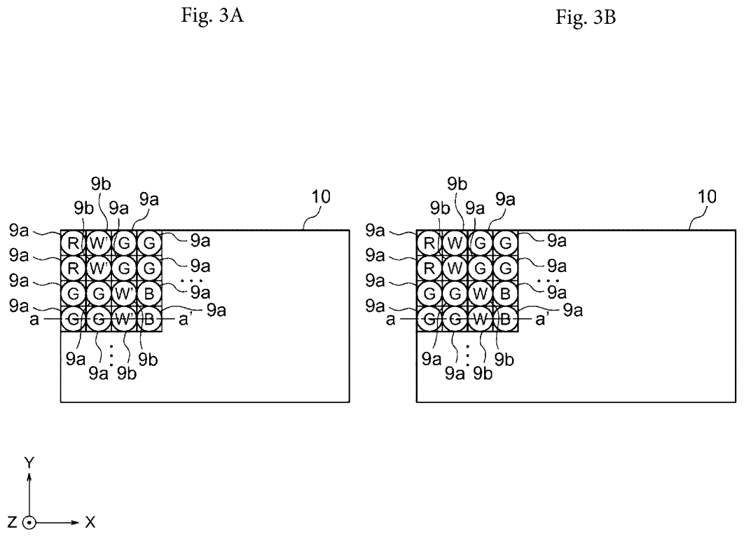

FIG. 3 depict plan diagrams depicting layouts and the like of the respective pixels in the pixel array unit according to the first embodiment.

FIG. 3A depicts a layout of the pixel array unit 10 including gradation pixels 9a and event pixels 9b according to the present embodiment, while FIG. 3B depicts a layout of the pixel array unit 10 including the gradation pixels 9a and the event pixels 9b in another mode of the present embodiment.

FIG. 3 illustrates an X axis, a Y axis, and Z axis perpendicular to each other. Each of an X direction and a Y direction corresponds to a lateral direction (horizontal direction), while a Z direction corresponds to a longitudinal direction (vertical direction). In addition, a +Z direction corresponds to an upward direction, while Z direction corresponds to a downward direction. Note that the Z direction may be aligned with the gravity direction either exactly or inexactly.

According to the examples in FIG. 3A and FIG. 3B, the pixel array unit 10 defines one unit of color arrangement constituted by the four gradation pixels 9a or event pixels 9b provided in a row direction (X direction), and the four gradation pixels 9a or event pixels 9b provided in a column direction (Y direction). This unit will be also simply expressed as the 4×4 pixels 9. Moreover, in the examples in FIG. 3A and FIG. 3B, this unit is cyclically arranged in the X direction and the Y direction. The color arrangement will be hereinafter described on the basis of this unit.

According to the examples of FIG. 3A and FIG. 3B, the gradation pixel 9a having red R color arrangement, the event pixel 9b, the gradation pixel 9a having green G color arrangement, and the gradation pixel 9a having green G color arrangement are arranged in this order from the left in each of a first row and a second row of the pixel array unit 10. In addition, the gradation pixel 9a having green G color arrangement, the gradation pixel 9a having green G color arrangement, the event pixel 9b, and the gradation pixel 9a having blue B color arrangement are arranged in this order from the left in each of a third row and a fourth row. This pixel arrangement is an arrangement suited for remosaic for converting the event pixels 9b into pixels in a Bayer array.

For achieving the color arrangements in red R, blue B, and green G, color filters in the respective colors for transmitting light in predetermined wavelength bands are provided on the respective pixels 9 in the corresponding colors in the pixel array unit 10. The gradation pixels 9a each having a red R color filter, the gradation pixels 9a each having a green G color filter, and the gradation pixels 9a each having a blue B color filter will be hereinafter also referred to as the red R gradation pixels 9a, the green G gradation pixels 9a, and the blue B gradation pixels 9a, respectively.

Moreover, each of the event pixels 9b has white color arrangement in FIG. 3A and FIG. 3B. Each of the event pixels 9b of the pixel array unit 10 in FIG. 3A includes a lens member, and has white color arrangement. The lens member transmits light in various colors (wavelengths) contained in visible light similarly to a white color filter. Accordingly, each of the event pixels 9b in FIG. 3A has white color arrangement. Each of the event pixels 9b in FIG. 3B has a white color filter instead of the lens member, and has white color arrangement different from that of the lens member. Specifically, each of the lens member and the white color filter transmits light in various colors contained in visible light. However, components and characteristics of light transmitted through the white color filter are different from components and characteristics of light transmitted through the lens member. For distinction between the color arrangements of the lens member and the white color filter, the white color arrangement of the white color filter will be hereinafter expressed as white W, while the white color arrangement of the lens member will be expressed as white W′.

According to the present embodiment, each of the respective gradation pixels 9a and the event pixels 9b included in the pixel array unit 10 has a color filter and has a predetermined color arrangement. Moreover, any part of the color arrangements of the 4×4 pixels 9 in the pixel array unit 10 rotated in an X-Y plane by 180 degrees around a rotation axis located at a center of the 4×4 pixels 9 does not agree with the corresponding part of the color arrangements in the pixel array unit 10 before rotation. According to this example, in a case where the 4×4 pixels 9 are rotated in the X-Y plane by 180 degrees around the rotation axis located at the center of the 4×4 pixels 9, positions of the red R gradation pixels 9a and the blue B gradation pixels 9a come to opposite positions of the original positions before rotation.

This disagreement between a color arrangement in any part of a color arrangement unit of the pixels 9 rotated in the X-Y plane by 180 degrees around the rotation axis located at the center of the color arrangement unit of the pixels 9, and a corresponding color arrangement in the pixel array unit 10 before rotation is called “having no 180-degree rotational symmetry.” Furthermore, a ratio of the number of the event pixels 9b to the total number of the event pixels 9b and the gradation pixels 9a included in the pixel array unit 10 is 25% or smaller.

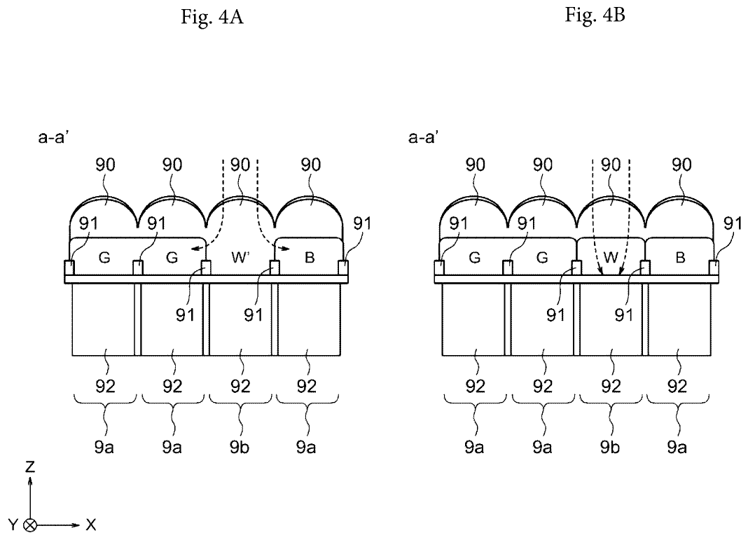

FIG. 4 depict cross-sectional diagrams taken along a line a-a′ and depicting the pixel array unit and the like including the gradation pixels 9a and the event pixels 9b according to the first embodiment.

FIG. 4A is a cross-sectional diagram taken along the line a-a′ in FIG. 3A, while FIG. 4B is a cross-sectional diagram taken along the line a-a′ in FIG. 3B.

Moreover, according to the examples depicted in FIG. 4A and FIG. 4B, each of the pixels 9 has an on-chip lens 90 and a photodiode 92. In addition, interpixel light shielding films 91 are provided between the respective pixels 9. Other components are not depicted in the examples in FIG. 4A and FIG. 4B.

Each of the on-chip lenses 90 collects incident light. Each of the interpixel light shielding films 91 chiefly prevents color mixture caused by light entering the predetermined pixel 9 at an oblique angle and intruding into the adjacent different pixel 9. In addition, each of the photodiodes 92 achieves photoelectric conversion of incident light.

Light exhibits a bending property in a direction from a medium having a low refractive index toward a medium having a high refractive index in accordance with Snell's law. Assuming that refractive indexes of air, a lens member, a red R color filter, a green G color filter, a blue B color filter, and a white W color filter are n₁, n_{w1}, n_{R}, n_{G}, n_{B}, and n_{w2}, respectively, the respective refractive indexes generally have the following relation in Expression (1).

$${n}_{1} < {n}_{w 1} < {n}_{R} , {n}_{G} , {n}_{B} < {n}_{w 2} \qquad ( 1 )$$

FIG. 4A depicts an example of color mixture caused by light (refractive index n_{w1}) entering the lens member of the event pixel 9b and intruding, via the on-chip lens 90, into the green G color filter (refractive index n_{G}) and the blue B color filter (refractive index n_{B}) both located adjacent to the event pixel 9b. Each of the refractive index n_{G} of the green G color filter and the refractive index n_{B} of the blue B color filter is higher than the refractive index n_{L} of the lens member. Accordingly, the incident light having entered the lens member is refracted according to this relation, and intrudes into the green G and blue B color filters. As a result, color mixture is caused from the event pixel 9b to the gradation pixels 9a. Particularly, light having a long wavelength such as red is mixed with the blue B color filter, and may cause deterioration of image quality.

FIG. 4B depicts an example of color mixture reduction according to the present embodiment. The refractive index n_{w2} of the white W color filter is higher than the refractive index ng of the green G color filter and the refractive index ng of the blue B color filter. In this relation, incident light does not intrude into the green G and blue B color filters both adjacent to the white W color filter. Accordingly, reduction of color mixture is achievable.

According to the present embodiment, the white W color filter having a relatively high refractive index is provided on each of the event pixels 9b. Accordingly, in comparison with a state of no color filter, the pixel array unit 10 is capable of reducing color mixture caused by intrusion of incident light from the event pixel 9b into the gradation pixels 9a. Moreover, the pixel array unit 10 is capable of preventing image quality deterioration by reducing non-uniform color mixture caused at the gradation pixels 9a such as green G and blue B gradation pixels 9a adjacent to the event pixels 9b.

Furthermore, according to the present embodiment, the pixel array unit 10 having the white W color filter on each of the event pixels 9b is capable of reducing a drop of sensitivity to acquire luminance information.

### Second Embodiment

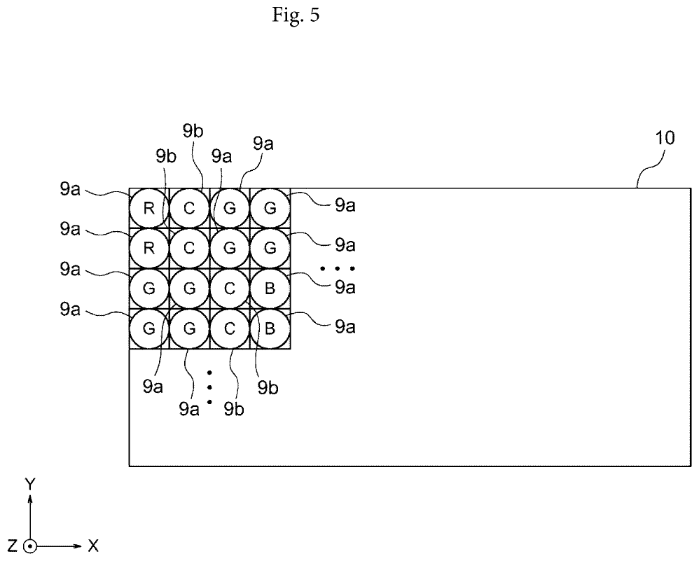

FIG. 5 is a plan diagram depicting a layout and the like of the respective pixels 9 in the pixel array unit according to a second embodiment.

Unlike the first embodiment, each of the event pixels 9b according to the present embodiment has a cyan C color filter instead of the white W color filter. Unlike the white W color filter, it is difficult for the cyan C color filter to transmit light having a long wavelength (approximately 600 nm or longer). The event pixels 9b each having the cyan C color filter will be hereinafter also referred to as the cyan C event pixels 9b.

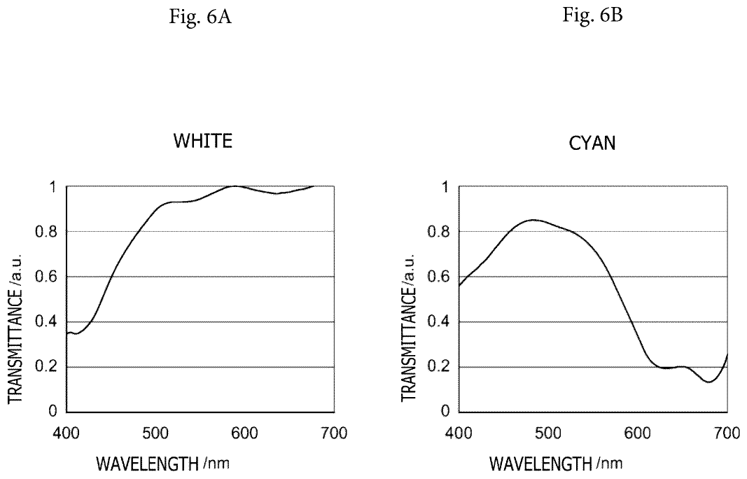

FIG. 6 depict diagrams illustrating an example of transmittance of each of the white color filter and the cyan color filter.

FIG. 6A illustrates an example of transmittance of the white W color filter for the respective wavelengths, while FIG. 6B illustrates an example of transmittance of the cyan C color filter for the respective wavelengths.

As illustrated in FIG. 6A, the white W color filter transmits light having a wavelength of approximately 600 nm or longer. On the other hand, according to a characteristic of the cyan C color filter illustrated in FIG. 6B, it is difficult for the cyan C color filter to transmit light having a wavelength of approximately 600 nm or longer. Accordingly, by providing the cyan C color filter on each of the event pixels 9b, color mixture caused by intrusion of light having a long wavelength into the adjacent gradation pixels 9a can be reduced.

According to the present embodiment, the cyan C color filter is provided on each of the event pixels 9b. Accordingly, in comparison with a state of no color filter, the pixel array unit 10 achieves reduction of color mixture caused by intrusion of incident light from the event pixels 9b into the gradation pixels 9a.

Furthermore, according to the present embodiment where the cyan C color filter is provided on each of the event pixels 9b, the pixel array unit 10 achieves more reduction of color mixture of light having a long wavelength than the configuration including the white W color filters. Particularly, the pixel array unit 10 is capable of preventing image quality deterioration by reducing color mixture caused at the blue B gradation pixels 9a adjacent to the event pixels 9b.

### Third Embodiment

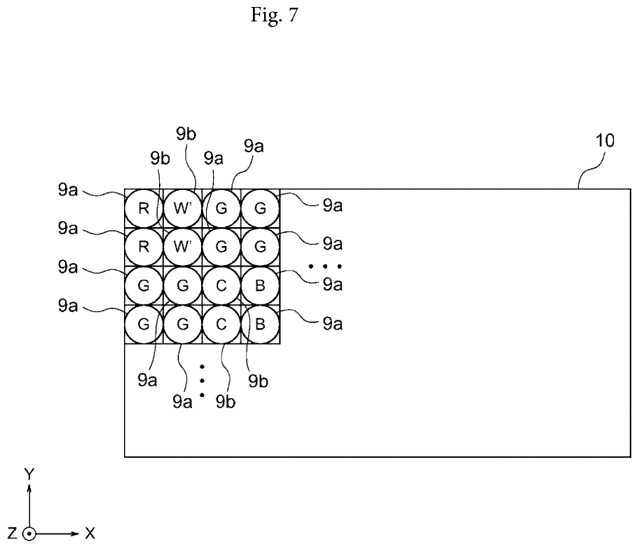

FIG. 7 is a plan diagram depicting a layout of the respective pixels in the pixel array unit according to a third embodiment.

The arrangement of the respective event pixels 9b and the respective gradation pixels 9a of the pixel array unit 10 in the present embodiment is similar to that arrangement in the first embodiment. In addition, unlike the first embodiment, each of the event pixels 9b adjacent to the blue B gradation pixels 9a in the pixel array unit 10 of the present embodiment has a cyan color filter. Moreover, each of the event pixels 9b adjacent to the pixels other than the blue B gradation pixels 9a has a lens member.

Similarly to the above embodiments, the color arrangement of the gradation pixels 9a and the event pixels 9b included in the pixel array unit 10 according to the present embodiment does not have 180-degree rotational symmetry. Furthermore, a ratio of the number of the event pixels 9b to the total number of the event pixels 9b and the gradation pixels 9a included in the pixel array unit 10 is 25% or smaller.

According to the present embodiment, color mixture from the cyan C event pixels 9b to the adjacent blue B gradation pixels 9a can be reduced. Moreover, each of the event pixels 9b located adjacent to the gradation pixels 9a other than the blue B gradation pixels 9a has the lens member. Accordingly, the event pixels 9b capable of securing a larger amount of incident light achieve reduction of a drop of sensitivity.

### Fourth Embodiment

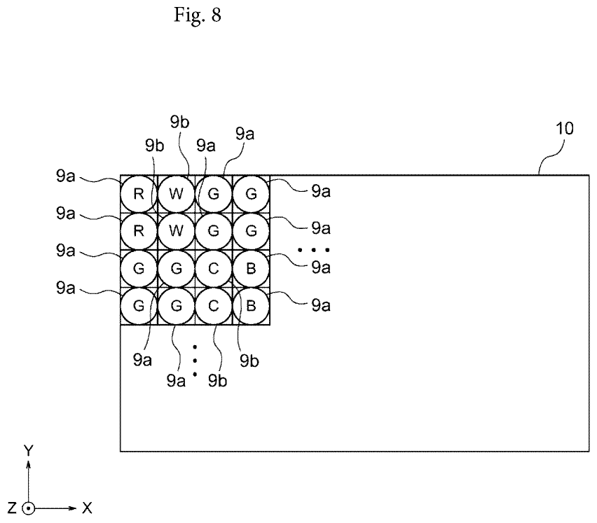

FIG. 8 is a plan diagram depicting a layout of the respective pixels in the pixel array unit according to a fourth embodiment.

The arrangement of the respective event pixels 9b and the respective gradation pixels 9a of the pixel array unit 10 in the present embodiment is similar to that arrangement in the first embodiment. In addition, unlike the first embodiment, each of the event pixels 9b adjacent to the blue B gradation pixels 9a has a cyan color filter in the pixel array unit 10 of the present embodiment. Moreover, each of the event pixels 9b located adjacent to the pixels other than the blue B gradation pixels 9a has a white W color filter.

Similarly to the above embodiments, the color arrangement of the gradation pixels 9a and the event pixels 9b included in the pixel array unit 10 according to the present embodiment does not have 180-degree rotational symmetry. Furthermore, a ratio of the number of the event pixels 9b to the total number of the event pixels 9b and the gradation pixels 9a included in the pixel array unit 10 is 25% or smaller.

According to the present embodiment, the pixel array unit 10 is capable of reducing color mixture of light having a long wavelength from the cyan C event pixels 9b to the adjacent blue B gradation pixels 9a. Moreover, each of the event pixels 9b located adjacent to the gradation pixels 9a other than the blue B gradation pixels 9a has the white W color filter. Accordingly, the pixel array unit 10 achieves reduction of color mixture from the event pixels 9b each having the white W color filter into the adjacent gradation pixels 9a while reducing a drop of sensitivity.

### Fifth Embodiment

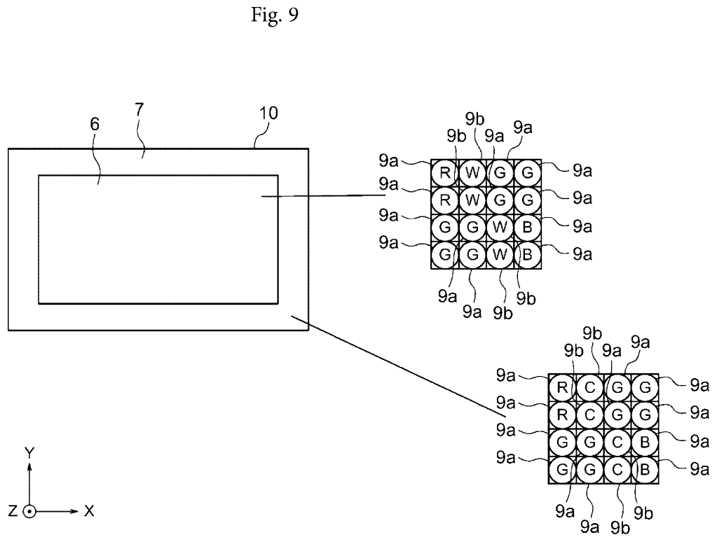

FIG. 9 is a plan diagram depicting a layout of the respective pixels in the pixel array unit according to a fifth embodiment.

The arrangement of the respective event pixels 9b and the respective gradation pixels 9a of the pixel array unit 10 in the present embodiment is similar to that arrangement in the first embodiment.

Meanwhile, in the pixel array unit 10 according to the present embodiment, a color arrangement in a central portion 6 of the pixel array unit 10 (a central portion within the angle of view) is different from a color arrangement in a peripheral portion 7 of the pixel array unit 10 (an outer portion within the angle of view). Each of the event pixels 9b in the central portion 6 has a white W color filter, while each of the event pixels 9b in the peripheral portion 7 has a cyan C color filter.

According to the present embodiment, the color arrangement of the gradation pixels 9a and the event pixels 9b included in the pixel array unit 10 in each of the central portion 6 and the peripheral portion 7 does not have 180-degree rotational symmetry. Furthermore, a ratio of the number of the event pixels 9b to the total number of the event pixels 9b and the gradation pixels 9a included in the pixel array unit 10 is 25% or smaller.

A range of the central portion 6 and a range of the peripheral portion 7 are sufficient to have a relative positional relation. Specifically, it is sufficient that each of the event pixels 9b in the central portion within the angle of view has a white W color filter and that each of the event pixels 9b located in the outer portion within the angle of view in the area surrounding the central portion has a cyan C color filter.

Generally, color mixture is more frequently caused in the peripheral portion 7 where incident light has a larger incident angle than in the central portion 6. According to the present embodiment, color mixture caused by intrusion of incident light from the event pixels 9b into the gradation pixels 9a can be reduced in comparison with a state of no color filter. Particularly, color mixture of light having a high wavelength with the blue B gradation pixels 9a in the peripheral portion 7 can be reduced.

Moreover, the white W color filter which is provided on each of the event pixels 9b in the central portion 6. Accordingly, a larger amount of incident light is securable, and therefore reduction of a drop of sensitivity is achievable.

### Sixth to Eighth Embodiments

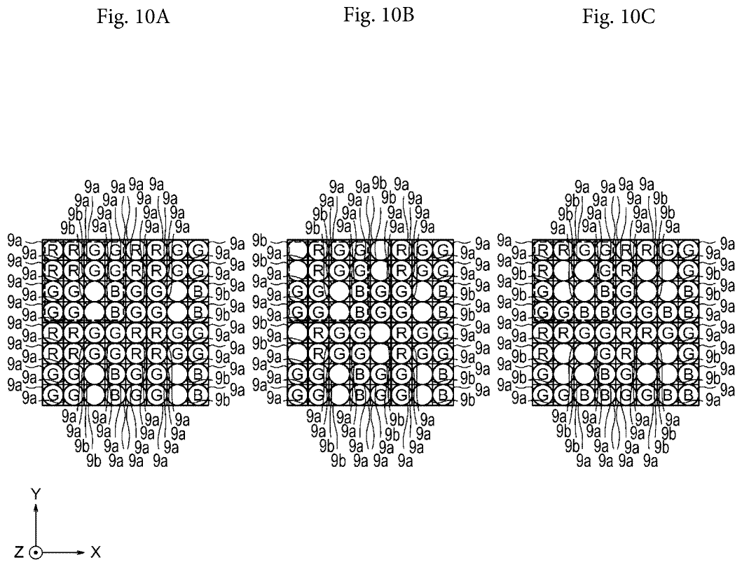

FIG. 10 depict plan diagrams depicting layouts of the respective pixels in the pixel array unit according to sixth to eighth embodiments.

FIG. 10A is a layout of the respective pixels 9 in the pixel array unit 10 according to the sixth embodiment, FIG. 10B is a layout of the respective pixels 9 in the pixel array unit 10 according to the seventh embodiment, and FIG. 10C is a layout of the respective pixels 9 in the pixel array unit 10 according to the eighth embodiment.

According to the examples in FIGS. 10A to 10C, the pixel array unit 10 has one unit of color arrangement constituted by the four gradation pixels 9a or event pixels 9b provided in the row direction (X direction), and the four gradation pixels 9a or event pixels 9b provided in the column direction (Y direction). Moreover, this unit is cyclically arranged in the X direction and the Y direction. A portion surrounded by a broken line in each of FIGS. 10A to 10C represents a unit of one color arrangement. The color arrangement will be hereinafter described on the basis of this unit.

In the example of FIG. 10A (seventh embodiment), the red R gradation pixel 9a, the red R gradation pixel 9a, the green G gradation pixel 9a, and the green G gradation pixel 9a are arranged in this order from the left in each of a first row and a second row of the pixel array unit 10. In addition, the green G gradation pixel 9a, the green G gradation pixel 9a, the event pixel 9b, and the blue B gradation pixel 9a are arranged in this order from the left in each of a third row and a fourth row.

In the example of FIG. 10B (eighth embodiment), the event pixel 9b, the red R gradation pixel 9a, the green G gradation pixel 9a, and the green G gradation pixel 9a are arranged in this order from the left in each of a first row and a second row of the pixel array unit 10. In addition, the green G gradation pixel 9a, the green G gradation pixel 9a, the event pixel 9b, and the blue B gradation pixel 9a are arranged in this order from the left in each of a third row and a fourth row.

In the example of FIG. 10C (ninth embodiment), the red R gradation pixel 9a, the red R gradation pixel 9a, the green G gradation pixel 9a, and the green G gradation pixel 9a are arranged in this order from the left in a first row of the pixel array unit 10. Moreover, the red R gradation pixel 9a, the event pixel 9b, the event pixel 9b, and the green G gradation pixel 9a are arranged in a second row of the pixel array unit 10. Furthermore, the green G gradation pixel 9a, the event pixel 9b, the event pixel 9b, and the blue B gradation pixel 9a are arranged in a third row of the pixel array unit 10. In addition, the green G gradation pixel 9a, the green G gradation pixel 9a, the blue B gradation pixel 9a, and the blue B gradation pixel 9a are arranged in a fourth row.

In each of FIGS. 10A to 10C, at least a part of the event pixels 9b in the pixel array unit 10 may have a white W color filter or a cyan C color filter each. Moreover, at least a part of the event pixels 9b may each have a lens member. For example, it is possible that each of the event pixels 9b has a lens member, a white W color filter, or a cyan C color filter. It is further possible that the each of event pixels 9b adjacent to the blue B gradation pixels 9a has a cyan C color filter and that each of the event pixels 9b adjacent to the pixels other than the blue B gradation pixels 9a has a lens member or a white W color filter.

Similarly to the above embodiments, the color arrangement of the 4×4 pixels in the pixel array unit 10 according to the sixth to eighth embodiment does not have 180-degree rotational symmetry. Furthermore, a ratio of the number of the event pixels 9b to the total number of the event pixels 9b and the gradation pixels 9a included in the pixel array unit 10 is 25% or smaller.

According to the present embodiment, the pixel array unit 10 is allowed to have various arrangements of the event pixels 9b and the gradation pixels 9a in a form suited for remosaic.

### Ninth to Tenth Embodiments

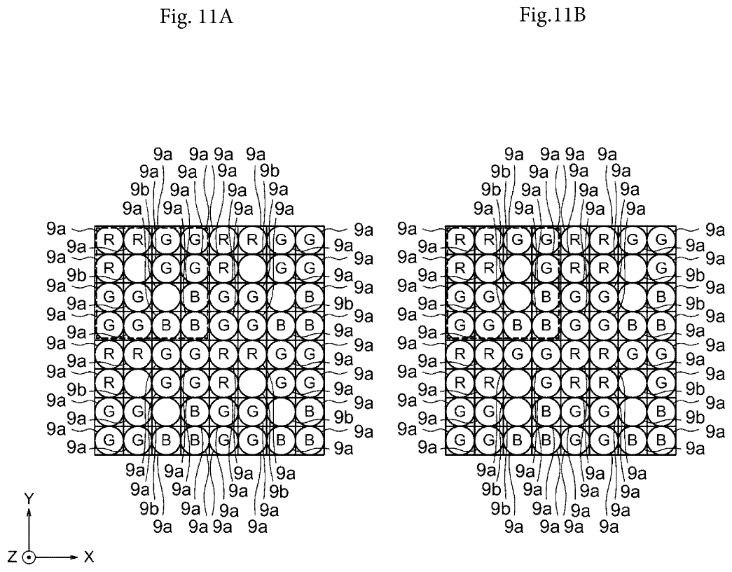

FIG. 11 depicts plan diagrams depicting layouts of the respective pixels in the pixel array unit according to ninth to tenth embodiments.

FIG. 11A is a layout of the respective pixels 9 in the pixel array unit 10 according to the ninth embodiment, and FIG. 11B is a layout of the respective pixels 9 in the pixel array unit 10 according to the tenth embodiment.

According to the examples in FIGS. 11A and 11B, the pixel array unit 10 has one unit of color arrangement constituted by the four gradation pixels 9a or event pixels 9b provided in the row direction (X direction), and the four gradation pixels 9a or event pixels 9b provided in the column direction (Y direction). Moreover, this unit is cyclically arranged in the X direction and the Y direction. A portion surrounded by a broken line in each of FIGS. 11A and 11B represents a unit of one color arrangement. The color arrangement will be hereinafter described on the basis of this unit.

In the example of FIG. 10A (ninth embodiment), the red R gradation pixel 9a, the red R gradation pixel 9a, the green G gradation pixel 9a, and the green G gradation pixel 9a are arranged in this order from the left in a first row of the pixel array unit 10. Moreover, the red R gradation pixel 9a, the event pixel 9b, the green G gradation pixel 9a, and the green G gradation pixel 9a are arranged in a second row of the pixel array unit 10. Furthermore, the green G gradation pixel 9a, the green G gradation pixel 9a, the event pixel 9b, and the blue B gradation pixel 9a are arranged in a third row of the pixel array unit 10. In addition, the green G gradation pixel 9a, the green G gradation pixel 9a, the blue B gradation pixel 9a, and the blue B gradation pixel 9a are arranged in a fourth row of the pixel array unit 10.

In the example of FIG. 10B (tenth embodiment), the red R gradation pixel 9a, the red R gradation pixel 9a, the green G gradation pixel 9a, and the green G gradation pixel 9a are arranged in this order from the left in a first row of the pixel array unit 10. Moreover, the red R gradation pixel 9a, the red R gradation pixel 9a, the event pixel 9b, and the green G gradation pixel 9a are arranged in a second of row of the pixel array unit 10. Furthermore, the green G gradation pixel 9a, the green G gradation pixel 9a, the event pixel 9b, and the blue B gradation pixel 9a are arranged in this order from the left in a third row of the pixel array unit 10. In addition, the green G gradation pixel 9a, the green G gradation pixel 9a, the blue B gradation pixel 9a, and the blue B gradation pixel 9a are arranged in a fourth row of the pixel array unit 10.

In each of FIGS. 11A and 11B, at least a part of the event pixels 9b in the pixel array unit 10 may have a white W color filter or a cyan C color filter each. Moreover, at least a part of the event pixels 9b may each have a lens member. For example, it is possible that each of the event pixels 9b has a lens member, a white W color filter, or a cyan C color filter. It is further possible that the event pixel 9b adjacent to the blue B gradation pixels 9a has a cyan C color filter and that the event pixel 9b adjacent to the pixels other than the blue B gradation pixels 9a has a lens member or a white W color filter.

Similarly to the above embodiments, the color arrangement of the gradation pixels 9a and the event pixels 9b included in the pixel array unit 10 according to the ninth to tenth embodiments does not have 180-degree rotational symmetry. Furthermore, a ratio of the number of the event pixels 9b to the total number of the event pixels 9b and the gradation pixels 9a included in the pixel array unit 10 is 25% or smaller.

According to the present embodiment, the pixel array unit 10 is allowed to have various arrangements of the event pixels 9b and the gradation pixels 9a in a form suited for remosaic.

### Eleventh Embodiment

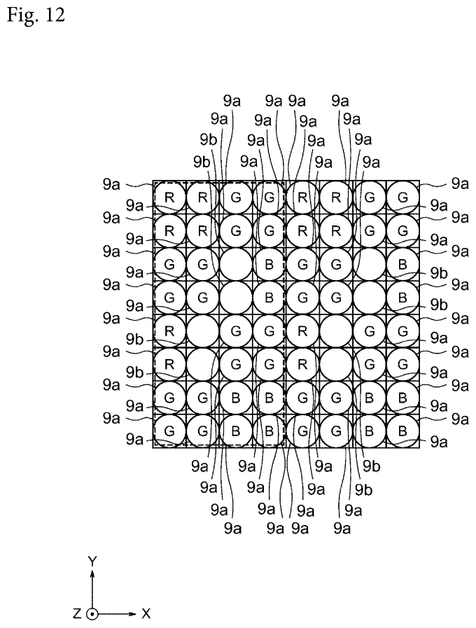

FIG. 12 is a plan diagram depicting a layout and the like of the respective pixels in the pixel array unit according to an eleventh embodiment.

According to the examples in FIG. 12, one unit of color arrangement is constituted by the four gradation pixels 9a or event pixels 9b provided in the row direction (X direction), and the eight gradation pixels 9a or event pixels 9b provided in the column direction (Y direction). This unit will be also simply expressed as the 4×8 pixels 9. Moreover, this unit is cyclically arranged in the X direction and the Y direction. A portion surrounded by a broken line in FIG. 12 represents a unit of one color arrangement. The color arrangement will be hereinafter described on the basis of this unit.

In the example in FIG. 12, the red R gradation pixel 9a, the red R gradation pixel 9a, the green G gradation pixel 9a, and the green G gradation pixel 9a are arranged in this order from the left in each of a first row and a second row of the pixel array unit 10. Furthermore, the green G gradation pixel 9a, the green G gradation pixel 9a, the event pixel 9b, and the blue B gradation pixel 9a are arranged in each of a third row and a fourth row of the pixel array unit 10. Moreover, the red R gradation pixel 9a, the event pixel 9b, the green G gradation pixel 9a, and the green G gradation pixel 9a are arranged in each of a fifth row and a sixth row of the pixel array unit 10. In addition, the green G gradation pixel 9a, the green G gradation pixel 9a, the blue B gradation pixel 9a, and the blue B gradation pixel 9a are arranged in each of a seventh and an eighth row of the pixel array unit 10.

In FIG. 12, at least a part of the event pixels 9b in the pixel array unit 10 may have a white W color filter or a cyan C color filter each. Moreover, at least a part of the event pixels 9b may each have a lens member. For example, it is possible that each of the event pixels 9b has a lens member, a white W color filter, or a cyan C color filter. It is further possible that the event pixel 9b adjacent to the blue B gradation pixels 9a has a cyan C color filter and that the event pixel 9b adjacent to the pixels other than the blue B gradation pixels 9a has a lens member or a white W color filter.

According to the eleventh embodiment, a color arrangement unit of the gradation pixels 9a and the event pixels 9b of the 4×8 pixels 9 included in the pixel array unit 10 and rotated in the X-Y plane by 180 degrees around a rotation axis located at a center of the 4×8 pixels 9 does not have rotational symmetry in comparison with a color arrangement before rotation. Furthermore, a ratio of the number of the event pixels 9b to the total number of the event pixels 9b and the gradation pixels 9a included in the pixel array unit 10 is 25% or smaller.

According to the present embodiment, the pixel array unit 10 is allowed to have various arrangements of the event pixels 9b and the gradation pixels 9a in a form suited for remosaic.

### Twelfth Embodiment

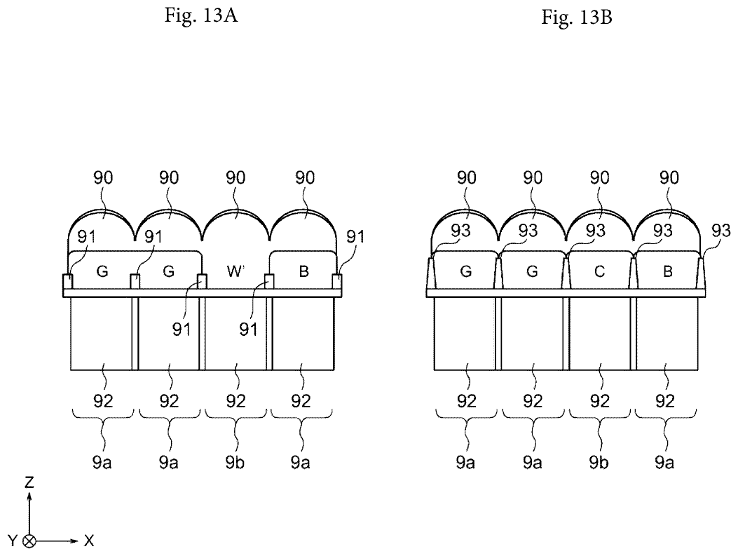

FIG. 13 depicts examples of cross-sectional diagrams of the pixel array unit and the like according to a twelfth embodiment.

FIG. 13A is an example of a cross-sectional diagram of the gradation pixels 9a and the event pixels 9b included in the pixel array unit 10 in a comparative example, while FIG. 13B is an example of a cross-sectional diagram of the gradation pixels 9a and the event pixels 9b included in the pixel array unit 10 according to the present embodiment. The pixel arrangement and the color arrangement in the present embodiment are not limited to those depicted in FIG. 13B. For example, the pixel arrangement and the color arrangement in any one of the first to eleventh embodiments may be adopted.

The interpixel light shielding films 91 are provided between the respective color filters in the pixel array unit 10 in the cross-sectional diagram depicted in FIG. 13A. Each of the interpixel light shielding films 91 including a metal material such as tungsten chiefly reduces color mixture caused light entering the on-chip lens 90 in an oblique direction and intruding into the adjacent pixels 9.

Meanwhile, first light shielding walls 93, which are walls including a low refractive index material and separating the respective color filters, are provided between the respective color filters in the pixel array unit 10 in the cross-sectional diagram depicted in FIG. 13B. For example, each of the first light shielding walls 93 is constituted by a silicon oxide film. The material of the first light shielding walls 93 is not limited to this example, but may be any material as long as such a relation is satisfied that each of the low refractive index materials of the first light shielding walls 93 has a lower refractive index than each of the refractive indexes of the color filters. A structure of the first light shielding walls 93 will be herein referred to as a low refractive index material structure or an NKB (low-N KaBe) structure.

According to the present embodiment, the pixel array unit 10 having the first light shielding walls 93 is capable of reducing color mixture between the color filters. Moreover, the pixel array unit 10 is capable of improving quantum efficiency (Qe).

### Thirteenth Embodiment

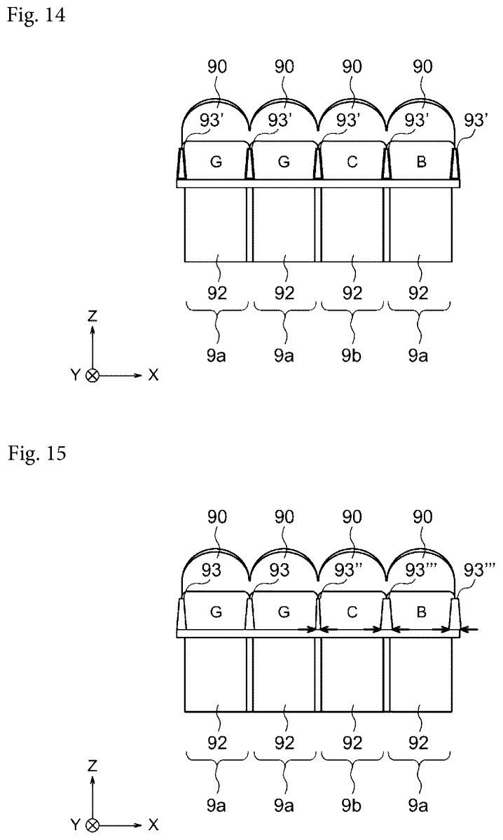

FIG. 14 is an example of a cross-sectional diagram of the pixel array unit according to a thirteenth embodiment.

The cross-sectional diagram depicted in FIG. 14 is an example of the gradation pixels 9a and the event pixels 9b included in the pixel array unit 10 according to the present embodiment. The pixel arrangement and the color arrangement in the present embodiment are not limited to those depicted in FIG. 14. For example, the pixel arrangement and the color arrangement in any one of the first to eleventh embodiments may be adopted.

The pixel array unit 10 in the cross-sectional diagram depicted in FIG. 14 has first light shielding walls 93′ between the respective gradation pixels 9a and the respective event pixels 9b similarly to the example in FIG. 13B. Unlike the example in FIG. 13, each of the first light shielding walls 93′ according to the present embodiment has a structure including air in the wall. Air has a refractive index of approximately 1. Accordingly, a low refractive index structure is produced by the presence of air. The structure of the first light shielding walls 93′ will be herein referred to as an air structure or an AKB (Air KaBe) structure.

According to the present embodiment, each of the first light shielding walls 93′ has the air structure. Accordingly, the refractive index can be made lower than that of the low refractive index material structure. Moreover, each of the first light shielding walls 93′ can reduce color mixture between the color filters. Furthermore, the pixel array unit 10 can improve quantum efficiency.

### Fourteenth Embodiment

FIG. 15 is an example of a cross-sectional diagram of the pixel array unit according to a fourteenth embodiment.

The cross-sectional diagram depicted in FIG. 15 is an example of the gradation pixels 9a and the event pixels 9b included in the pixel array unit 10 according to the present embodiment. The pixel arrangement and the color arrangement in the present embodiment are not limited to those depicted in FIG. 15. For example, the pixel arrangement and the color arrangement in any one of the first to eleventh embodiments may be adopted.

The pixel array unit 10 in the cross-sectional diagram depicted in FIG. 15 has the first light shielding walls 93, and first light shielding walls 93″ and 93″′ between the respective gradation pixels 9a and the respective event pixels 9b similarly to the example in FIG. 13B. Unlike the examples in FIG. 13B and FIG. 14, the first light shielding walls 93 to 93″′ according to the present embodiment are formed such that each of the first light shielding walls 93″ and 93″′ provided between the gradation pixels 9a and the adjacent event pixels 9b has a thickness different from each of the first light shielding walls 93 provided between the gradation pixels 9a and the gradation pixels 9a.

According to the present embodiment, each of the first light shielding walls 93′″ provided between the blue B gradation pixels 9a and the adjacent event pixels 9b has a larger thickness than each thickness of the first light shielding walls 93 provided between the gradation pixels 9a and the adjacent gradation pixels 9a. According to the configuration in FIG. 15, the first light shielding wall 93′″ provided between the blue B gradation pixel 9a and the adjacent cyan C event pixel 9b has a larger thickness than each thickness of the other first light shielding walls 93.

Moreover, according to the present embodiment, each of the first light shielding walls 93″ provided between the gradation pixels 9a each having a color filter other than blue B filter and the adjacent event pixels 9b has a smaller thickness than each thickness of the first light shielding walls 93 provided between the gradation pixels 9a and the adjacent gradation pixels 9a. According to the configuration in FIG. 15, the first light shielding wall 93″ provided between the green G gradation pixel 9a and the adjacent cyan C event pixel 9b has a smaller thickness.

In addition, while FIG. 15 depicts the example where each of the first light shielding walls 93 to 93′″ has a low refractive index material structure, an air structure may be adopted.

According to the present embodiment, the pixel array unit 10 can achieve further reduction of color mixture caused by light from the event pixels 9b to the blue B gradation pixels 9a by increasing the thicknesses of the first light shielding walls 93′″ provided between the blue B gradation pixels 9a and the adjacent event pixels 9b each having the cyan C color filter.

Moreover, according to the present embodiment, the pixel array unit 10 can improve sensitivity of the gradation pixels 9a and the event pixels 9b by reducing the thicknesses of the first light shielding walls 93 provided between the gradation pixels 9a having the color filters less affected by color mixture, such as red R and green G, and the adjacent event pixels 9b.

### Fifteenth Embodiment

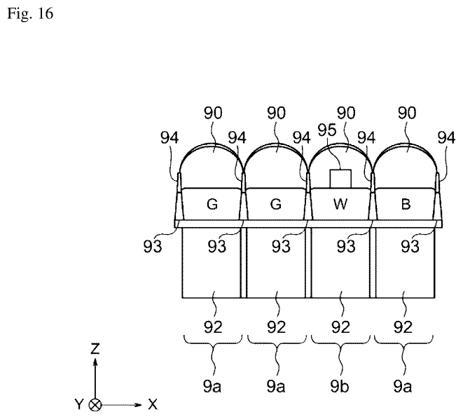

FIG. 16 is an example of a cross-sectional diagram of the pixel array unit according to a fifteenth embodiment.

A cross-sectional diagram depicted in FIG. 16 is an example of a cross-sectional diagram of the gradation pixels 9a and the event pixels 9b included in the pixel array unit 10. The pixel arrangement and the color arrangement in the present embodiment are not limited to those depicted in FIG. 16. For example, the pixel arrangement and the color arrangement in any one of the first to eleventh embodiments can be adopted.

The pixel array unit 10 in the cross-sectional diagram depicted in FIG. 16 has the first 133 provided between the respective gradation pixels 9a and the respective event pixels 9b similarly to the example in FIG. 13B.

According to the present embodiment, a second light shielding wall 94, which is a low refractive index material wall, is provided on each of the color filters of the event pixels 9b and the gradation pixels 9a between the corresponding color filter and the on-chip lens 90. For example, each of the second light shielding walls 94 is constituted by a silicon oxide film.

Moreover, according to this example, a waveguide 95, which is an optical path for incident light, is provided on each of the white W color filters included in the event pixels 9b. For example, each of the waveguides 95 includes a high refractive index material such as silicon nitride. In this case, each of the waveguide 95 functions as a passage for light entering an upper side of the event pixel 9b. Accordingly, color mixture into the adjacent gradation pixels 9a can be reduced. While described herein is the example which provides the waveguides 95 on the white W color filters, the waveguides 95 may be provided on the cyan C color filters.

Furthermore, each of the waveguides 95 may have a pillar shape. In this case, each of the waveguides 95 is capable of collecting a larger amount of incident light.

According to the present embodiment, the second light shielding walls 94 are provided on the color filters. Accordingly, the pixel array unit 10 can achieve reduction of color mixture caused by incident light from the on-chip lenses 90 into the adjacent pixels 9.

Moreover, the waveguides 95 are provided on the white W color filters or the cyan C color filters. Accordingly, the pixel array unit 10 can achieve reduction of color mixture into the adjacent pixels by the function of the waveguides 95 as passages for incident light.

### Sixteenth Embodiment

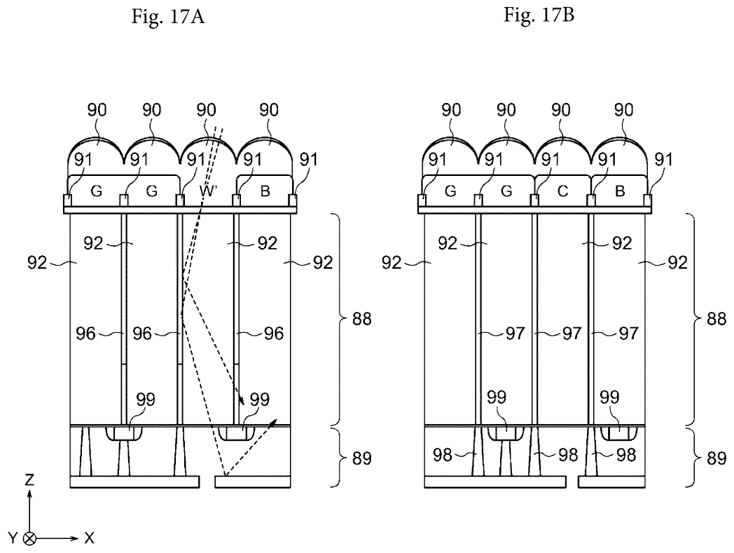

FIG. 17 depicts examples of cross-sectional diagrams of the pixel array unit and the like according to a sixteenth embodiment.

FIG. 17A is an example of a cross-sectional diagram of the gradation pixels 9a and the event pixels 9b included in the pixel array unit 10 in a comparative example, while FIG. 17B is an example of a cross-sectional diagram of the gradation pixels 9a and the event pixels 9b included in the pixel array unit 10 according to the present embodiment. The pixel arrangement and the color arrangement in the present embodiment are not limited to those depicted in FIG. 17B. For example, the pixel arrangement and the color arrangement in any one of the first to eleventh embodiments can be adopted.

An example of color mixture caused in a semiconductor substrate 88 and an insulation film 89 will be described with reference to FIG. 17A.

Light having entered the lens material of the event pixel 9b via the on-chip lens 90 is photoelectrically converted by the photodiode 92 within the semiconductor substrate 88. A part of the light having entered the photodiode 92 is totally reflected on an element separation insulation film 96, and enters an area of the adjacent photodiode 92. Moreover, a part of the light having entered the lens material of the event pixel 9b via the on-chip lens 90 is totally reflected within the insulation film 89 including a transfer transistor 99 and the like, and enters an area of the adjacent photodiode 92. In such a manner, color mixture is caused by incident height having entered the adjacent photodiode 92.

In FIG. 17B, the photodiode 92 is provided below each of the color filters within the semiconductor substrate 88. Moreover, third light shielding walls 97 are provided between the respective photodiodes 92. Each of the third light shielding walls 97 is a low refractive index material wall penetrating the inside of the semiconductor substrate 88. For example, each of the third light shielding walls 97 includes a material having a lower refractive index than that of the photodiodes 92.

Furthermore, as depicted in FIG. 17B, fourth light shielding walls 98, which are low refractive material walls, are provided between the respective pixels 9 in the insulation film 89 below the semiconductor substrate 88. For example, each of the fourth light shielding walls 98 includes a material having a lower refractive index than that of the insulation film 89.

While both types of the third light shielding walls 97 and the fourth light shielding walls 98 are formed integrally with each other in the example in FIG. 17B, a structure including only either the third light shielding walls 97 or the fourth light shielding walls 98 may be adopted. Moreover, the third light shielding walls 97 and the fourth light shielding walls 98 may be combined with the first light shielding walls 93 to 93″′, the second light shielding walls 94, and the waveguides 95 described above, and mounted on the pixel array unit 10.

According to the present embodiment, the semiconductor substrate 88 including the third light shielding walls 97 achieves reduction of color mixture caused by light entering the photodiodes 92.

Moreover, according to the present embodiment, the insulation film 89 including the fourth light shielding walls 98 can achieve reduction of color mixture caused by light having entered the insulation film 89.

### <<Configuration Example of Vehicle Control System>>

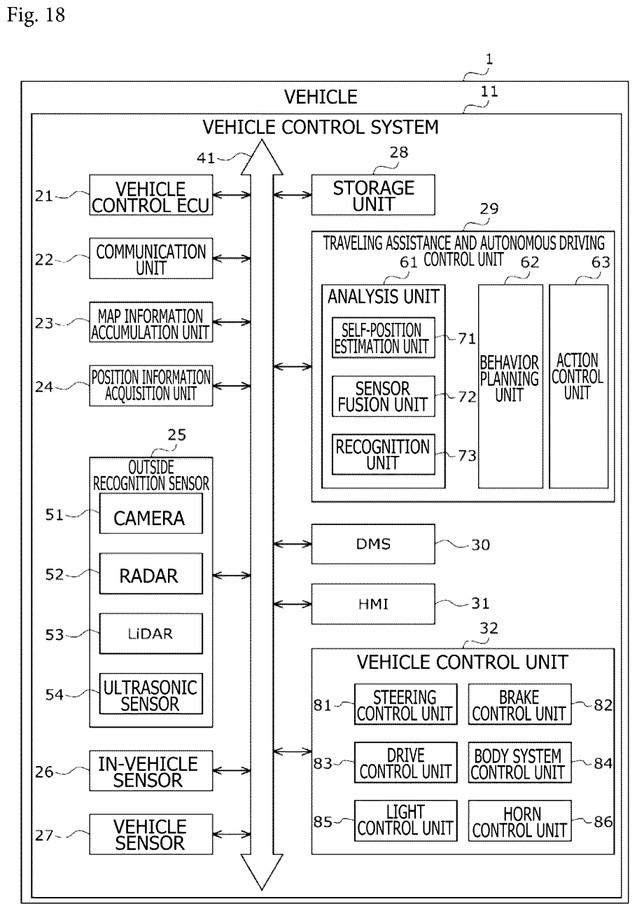

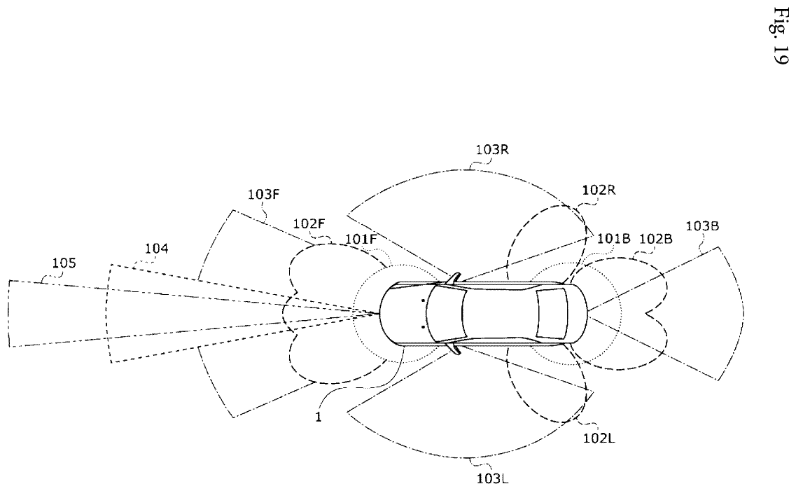

FIG. 18 is a block diagram depicting a configuration example of a vehicle control system 11 presented as one example of a moving device control system to which the present technology is applied.

The vehicle control system 11 is provided on a vehicle 1, and performs processing associated with traveling assistance and autonomous driving of the vehicle 1.

The vehicle control system 11 includes a vehicle control ECU (Electronic Control Unit) 21, a communication unit 22, a map information accumulation unit 23, a position information acquisition unit 24, an outside recognition sensor 25, an in-vehicle sensor 26, a vehicle sensor 27, a storage unit 28, a traveling assistance and autonomous driving control unit 29, a DMS (Driver Monitoring System) 30, an HMI (Human Machine Interface) 31, and a vehicle control unit 32.

The vehicle control ECU 21, the communication unit 22, the map information accumulation unit 23, the position information acquisition unit 24, the outside recognition sensor 25, the in-vehicle sensor 26, the vehicle sensor 27, the storage unit 28, the traveling assistance and autonomous driving control unit 29, the driver monitoring system (DMS) 30, the human machine interface (HMI) 31, and the vehicle control unit 32 are communicatively connected to each other via a communication network 41. For example, the communication network 41 includes an in-vehicle communication network in conformity with standards of digital bidirectional communication, such as a CAN (Controller Area Network), a LIN (Local Interconnect Network), a LAN (Local Area Network), FlexRay (registered trademark), and Ethernet (registered trademark), and further includes a bus and others. Different types of the communication network 41 may be selected according to types of data to be transferred. For example, a CAN may be applied to data associated with vehicle control, while Ethernet may be applied to mass data. Note that each unit of the vehicle control system 11 is connected not via the communication network 41, but directly via wireless communication in some cases on an assumption that communication to be established is relatively short-distance communication, such as near field communication (NFC) and Bluetooth (registered trademark).

Note that description of the communication network 41 will be hereinafter omitted even in a case where each unit of the vehicle control system 11 communicates with each other via the communication network 41. For example, in a case where the vehicle control ECU 21 and the communication unit 22 communicate with each other via the communication network 41, this situation will be simply described as “the vehicle control ECU 21 and the communication unit 22 communicate with each other.”

For example, the vehicle control ECU 21 includes a processor selected from various types of processors such as a CPU (Central Processing Unit) and an MPU (Micro Processing Unit). The vehicle control ECU 21 controls overall or a part of functions of the vehicle control system 11.

The communication unit 22 communicates with various devices inside and outside the vehicle, other vehicles, a server, a base station, and the like to transmit and receive various types of data. In this case, the communication unit 22 can use a plurality of communication systems to achieve communication.

An outline of communication achievable by the communication unit 22 with the outside of the vehicle will be described. For example, the communication unit 22 communicates with a server existing on an external network (hereinafter referred to as an external server) and the like via a base station or an access point by using a wireless communication system such as 5G (fifth generation mobile communication system), LTE (Long Term Evolution), and DSRC (Dedicated Short Range Communications). For example, the communication unit 22 communicates with the external network such as the Internet, a cloud network, or a network unique to a provider. The communication system adopted by the communication unit 22 to communicate with the external network is not particularly limited as long as the communication system is a wireless communication system capable of achieving digital bidirectional communication at a predetermined communication speed or higher and for a predetermined distance or longer.

Moreover, for example, the communication unit 22 is capable of communicating with a terminal located near the own vehicle by using a P2P (Peer To Peer) technology. For example, the terminal located near the own vehicle is a terminal attached to a mobile body moving at a relatively low speed, such as a pedestrian and a bicycle, a terminal installed at a fixed position of a store or the like, or an MTC (Machine Type Communication) terminal. Moreover, the communication unit 22 is capable of achieving V2X communication. V2X communication refers to communication between the own vehicle and others, such as vehicle to vehicle communication, vehicle to infrastructure communication for communicating with a roadside unit or the like, vehicle to home communication, and vehicle to pedestrian communication for communicating with a terminal or the like carried by a pedestrian.

For example, the communication unit 22 is capable of receiving from the outside a program for updating software which controls operations of the vehicle control system 11 (Over The Air). The communication unit 22 is further capable of receiving map information, traffic information, information associated with surroundings of the vehicle 1, and the like from the outside. Moreover, for example, the communication unit 22 is capable of transmitting information associated with the vehicle 1, information associated with surroundings of the vehicle 1, and the like to the outside. Examples of the information associated with the vehicle 1 and transmitted from the communication unit 22 to the outside include data indicating a state of the vehicle 1, and a recognition result obtained by a recognition unit 73. Furthermore, for example, the communication unit 22 achieves communication in conformity with a vehicle emergency report system such as e-calls.

For example, the communication unit 22 receives electromagnetic waves transmitted from a radio wave beacon, an optical beacon, and vehicle information and communication system (VICS) (registered trademark) available by FM multiplex broadcasting or the like.

An outline of communication achievable by the communication unit 22 with the interior of the vehicle will be described. The communication unit 22 is capable of communicating with each device inside the vehicle by wireless communication, for example. The communication unit 22 is capable of wirelessly communicating with the devices inside the vehicle by a communication system allowing digital bidirectional communication via wireless communication at a predetermined communication speed or higher, such as a wireless LAN, Bluetooth, NFC, and WUSB (Wireless USB). In addition, the communication unit 22 is capable of communicating with each device inside the vehicle by wired communication. For example, the communication unit 22 is capable of communicating with each device inside the vehicle via wired communication using a cable connected to a not-depicted connection terminal. The communication unit 22 is capable of communicating with each device inside the vehicle by a communication system allowing digital bidirectional communication via wired communication at a predetermined communication speed or higher, such as a USB (Universal serial Bus), HDMI (High-Definition Multimedia Interface) (registered trademark), and an MHL (Mobile High-definition Link).

For example, the devices inside the vehicle herein refer to devices provided inside the vehicle and not connected to the communication network 41. Examples assumed to constitute the devices inside the vehicle include a mobile device or a wearable device carried by an occupant such as a driver, and an information device brought into the vehicle and temporarily installed.

The map information accumulation unit 23 accumulates either one or both of a map acquired from the outside and a map created by the vehicle 1. For example, the map information accumulation unit 23 accumulates a three-dimensional high-precision map, and a global map less precise than the high-precision map and covering a wide area.

For example, the high-precision map is a dynamic map, a point cloud map, or a vector map. For example, the dynamic map is a map having four layers of dynamic information, semi-dynamic information, semi-static information, and static information, and is supplied from an external server or the like to the vehicle 1. The point cloud map is a map constituted by point clouds (point cloud data). For example, the vector map is a map which associates traffic information or the like, such as positions of lanes and traffic lights, with a point cloud map to apply the traffic information or the like to ADAS (Advanced Driver Assistance System) and AD (Autonomous Driving).

For example, each of the point cloud map and the vector map may be supplied from an external server or the like, or may be created by the vehicle 1 as a map for matching with a local map described below on the basis of a sensing result obtained by a camera 51, a radar 52, a LiDAR 53, or the like, and accumulated in the map information accumulation unit 23. In addition, in a case where a high-precision map is provided from an external server or the like, map data indicating a several hundred meters square map, for example, and associated with a planned route where the vehicle 1 is planning to travel is acquired from an external server or the like so as to reduce a communication volume.

The position information acquisition unit 24 receives a GNSS (Global Navigation Satellite System) signal from a GNSS satellite to acquire position information associated with the vehicle1. The acquired position information is supplied to the traveling assistance and autonomous driving control unit 29. Note that the position information acquisition unit 24 is not limited to adopting the system using the GNSS signal, but may acquire the position information by using a beacon, for example.

The outside recognition sensor 25 includes various sensors for recognizing a situation outside the vehicle 1, and supplies sensor data received from the respective sensors to each unit of the vehicle control system 11. The types and the number of the sensors included in the outside recognition sensor 25 may be any types and number.

For example, the outside recognition sensor 25 includes the camera 51, the radar 52, the LiDAR (Light Detection and Ranging, Laser Imaging Detection and Ranging) 53, and an ultrasonic sensor 54. Alternatively, the outside recognition sensor 25 may include at least one type of sensor selected from the camera 51, the radar 52, the LiDAR 53, and the ultrasonic sensor 54. Each number of the camera 51, the radar 52, the LiDAR 53, and the ultrasonic sensor 54 is not particularly limited as long as the number is a realistic number installable on the vehicle 1. Moreover, the types of the sensors included in the outside recognition sensor 25 are not limited to these examples. The outside recognition sensor 25 may have other types of sensors. An example of sensing areas of the respective sensors included in the outside recognition sensor 25 will be described below.

Note that an imaging method adopted by the camera 51 is not limited to a specific method. For example, cameras using various types of imaging methods capable of achieving distance measurement, such as a ToF (Time Of Flight) camera, a stereo camera, a monocular camera, and an infrared camera, are applicable to the camera 51 as necessary. Alternatively, the camera 51 may be a camera simply for acquiring captured images rather than a camera having a function of distance measurement.

Moreover, for example, the outside recognition sensor 25 may include an environment sensor for detecting an environment for the vehicle 1. The environment sensor is a sensor for detecting an environment such as weather, meteorology, and brightness, and may include various types of sensors such as a raindrop sensor, a fog sensor, a sunlight sensor, a snow sensor, and a luminance sensor.

Furthermore, for example, the outside recognition sensor 25 includes a microphone for detecting sounds around the vehicle 1, sound source positions, and for other purposes.

The in-vehicle sensor 26 includes various types of sensors for detecting information inside the vehicle, and supplies sensor data received from the respective sensors to each unit of the vehicle control system 11. The type and the number of each of the various sensors included in the in-vehicle sensor 26 are not particularly limited as long as the type and the number are a realistic type and a realistic number installable on the vehicle 1.

For example, the in-vehicle sensor 26 may include at least one type of sensor selected from a camera, a radar, a seat sensor, a steering wheel sensor, a microphone, and a biosensor. For example, cameras using various types of imaging methods capable of achieving distance measurement, such as a ToF camera, a stereo camera, a monocular camera, and an infrared camera, are applicable to the camera included in the in-vehicle sensor 26. Alternatively, the camera included in the in-vehicle sensor 26 may be a camera simply for acquiring captured images rather than a camera having a function of distance measurement. The biosensor included in the in-vehicle sensor 26 is provided on a seat or a steering wheel, for example, and detects various types of biological information associated with an occupant such as a driver.

The vehicle sensor 27 includes various types of sensors for detecting a state of the vehicle 1, and supplies sensor data received from the respective sensors to each unit of the vehicle control system 11. The type and the number of each of the various sensors included in the vehicle sensor 27 are not particularly limited as long as the type and the number are a realistic type and a realistic number installable on the vehicle 1.

For example, the vehicle sensor 27 includes a speed sensor, an acceleration sensor, an angular velocity sensor (gyro sensor), and an inertial measurement unit (IMU) integrating these sensors. For example, the vehicle sensor 27 includes a steering angle sensor for detecting a steering angle of the steering wheel, a yaw rate sensor, an accelerator sensor for detecting an operated amount of an accelerator pedal, and a brake sensor for detecting an operated amount of a brake pedal. For example, the vehicle sensor 27 includes a rotation sensor for detecting a rotation speed of an engine or a motor, an air pressure sensor for detecting an air pressure of a tire, a slip ratio sensor for detecting a slip ratio of a tire, and a wheel speed sensor for detecting a rotation speed of a wheel. For example, the vehicle sensor 27 includes a battery sensor for detecting a residual quantity and a temperature of a battery, and a shock sensor for detecting a shock received from the outside.

The storage unit 28 includes at least either a non-volatile storage medium or a volatile storage medium, and stores data and programs. For example, the storage unit 28 is used as an EEPROM (Electrically Erasable Programmable Read Only Memory) and a RAM (Random Access Memory). A magnetic storage device such as an HDD (Hard Disc Drive), a semiconductor storage device, an optical storage device, and a magneto-optical storage device are available as the storage medium. The storage unit 28 stores various programs and data used by each unit of the vehicle control system 11. For example, the storage unit 28 includes an EDR (Event Data Recorder) and a DSSAD (Data Storage System for Automated Driving), and stores information associated with the vehicle 1 before and after an event such as an accident, and information acquired by the in-vehicle sensor 26.

The traveling assistance and autonomous driving control unit 29 performs traveling assistance and autonomous driving control of the vehicle 1. For example, the traveling assistance and autonomous driving control unit 29 includes an analysis unit 61, a behavior planning unit 62, and an action control unit 63.

The analysis unit 61 performs an analysis process for analyzing situations in and around the vehicle 1. The analysis unit 61 includes a self-position estimation unit 71, a sensor fusion unit 72, and a recognition unit 73.

The self-position estimation unit 71 estimates a self-position of the vehicle 1 on the basis of sensor data received from the outside recognition sensor 25, and a high-precision map accumulated in the map information accumulation unit 23. For example, the self-position estimation unit 71 creates a local map on the basis of the sensor data received from the outside recognition sensor 25, and estimates the self-position of the vehicle 1 by matching between the local map and the high-precision map. For example, the position of the vehicle 1 is defined on the basis of a reference located at a center of a pair of axles of rear wheels.

For example, the local map is a three-dimensional high-precision map created by a technology such as SLAM (Simultaneous Localization and Mapping), or an occupancy grid map. For example, the three-dimensional high-precision map is a point cloud map described above. The occupancy grid map is a map produced by dividing a three-dimensional or a two-dimensional space around the vehicle 1 into grid units each having a predetermined size to indicate an occupation state of an object on the basis of the grid units. For example, the occupation state of the object is represented according to presence or absence of the object or a presence probability. For example, the local map is also used for a detection process and a recognition process performed by the recognition unit 73 to detect and recognize an outside situation of the vehicle 1.

Note that the self-position estimation unit 71 may estimate the self-position of the vehicle 1 on the basis of the position information acquired by the position information acquisition unit 24 and the sensor data received from the vehicle sensor 27.

The sensor fusion unit 72 performs a sensor fusion process for generating new information by combining a plurality of different types of sensor data (e.g., image data supplied from the camera 51, and sensor data supplied from the radar 52). The different types of sensor data are combined by a method such as integration, fusion, and association.

The recognition unit 73 executes a detection process for detecting a situation outside the vehicle 1, and a recognition process for recognizing a situation outside the vehicle 1.

For example, the recognition unit 73 performs the detection process and the recognition process concerning the situation outside the vehicle 1 on the basis of information received from the outside recognition sensor 25, information received from the self-position estimation unit 71, information received from the sensor fusion unit 72, and the like.

Specifically, for example, the recognition unit 73 performs the detection process, the recognition process, and the like concerning an object around the vehicle 1. For example, the detection process for detecting the object is a process for detecting presence or absence of the object, and a size, a shape, a position, a movement, and the like of the object. For example, the recognition process for recognizing the object is a process for recognizing an attribute of the object such as a type of the object, and identifying a specific object. Note that the detection process and the recognition process are not necessarily processes clearly separable from each other, but may overlap with each other.

For example, the recognition unit 73 detects the object around the vehicle on the basis of clustering which classifies point clouds corresponding to sensor data obtained by the radar 52, the LiDAR 53, or the like into point cloud groups. In this manner, the presence or absence, the size, the shape, and the position of the object around the vehicle 1 are detected.

For example, the recognition unit 73 detects the movement of the object around the vehicle 1 by tracking which follows movements of the point cloud groups classified by clustering. In this manner, a speed and a traveling direction (motion vector) of the object around the vehicle 1 are detected.

For example, the recognition unit 73 detects or recognizes a vehicle, a human, a bicycle, an obstacle, a structure, a road, a traffic light, a traffic sign, a road marking, and the like on the basis of image data supplied from the camera 51. Moreover, the recognition unit 73 may recognize the type of the object around the vehicle 1 by performing a recognition process such as semantic segmentation.

For example, the recognition unit 73 is capable of performing a recognition process for recognizing traffic rules around the vehicle 1 on the basis of a map accumulated in the map information accumulation unit 23, a self-position estimation result obtained by the self-position estimation unit 71, and a recognition result associated with the object around the vehicle 1 and obtained by the recognition unit 73. The recognition unit 73 performing this process is capable of recognizing a position and a state of a traffic light, details of a traffic sign and a road marking, details of traffic regulations, and lanes where the vehicle 1 is allowed to travel, and others.

For example, the recognition unit 73 is capable of performing a recognition process for recognizing an environment surrounding the vehicle 1. Examples of the surrounding environment assumed to be designated by the recognition unit 73 as a recognition target include weather, temperature, humidity, brightness, and a state of a road surface.

The behavior planning unit 62 creates a behavior plan for the vehicle 1. For example, the behavior planning unit 62 creates the behavior plan by performing a process for route planning and route following.

Note that route planning (Global path planning) is a process for planning a rough route from a start to a goal. This route planning also includes a process called track planning for performing track formation (Local path planning) which forms a route located near the vehicle 1 and allowing safe and smooth traveling of the vehicle 1 in the planned route in consideration of motion characteristics of the vehicle 1.

The route following is a process for planning an action achieving safe and accurate traveling along the route planned by the route planning within a planned time. For example, the behavior planning unit 62 is capable of calculating a target speed and a target angular velocity of the vehicle 1 on the basis of a result of this route following process.

The action control unit 63 controls an action of the vehicle 1 so as to achieve the behavior planning created by the behavior planning unit 62.

For example, the action control unit 63 controls a steering control unit 81, a brake control unit 82, and a drive control unit 83 included in the vehicle control unit 32 described below to achieve acceleration and deceleration control and direction control such that the vehicle 1 can travel on a track calculated by track planning. For example, the action control unit 63 performs cooperative control for a purpose of achieving ADAS functions such as collision avoidance or shock mitigation, following traveling, vehicle speed keeping traveling, own-vehicle shock warning, and own-vehicle lane departure warning. For example, the action control unit 63 performs cooperative control for a purpose of autonomous driving achieving autonomously traveling without a necessity of operation by the driver, or for other purposes.

The DMS 30 performs an authentication process for authenticating the driver, a recognition process for recognizing a state of the driver, and other processes on the basis of sensor data received from the in-vehicle sensor 26, input data and the like input to the HMI 31 described below, and others. Examples assumed to be designated as the state of the driver corresponding to a recognition target include a physical condition, a wakefulness level, a concentration level, a fatigue level, a visual line direction, a drunkenness level, a driving operation, and a posture.

Note that the DMS 30 may also perform an authentication process for authenticating an occupant other than the driver, and a recognition process for recognizing a state of this occupant. Moreover, for example, the DMS 30 may perform a recognition process for recognizing a situation inside the vehicle on the basis of sensor data received from the in-vehicle sensor 26. Examples of the situation inside the vehicle assumed to be designated as a recognition target include temperature, humidity, brightness, and smell.

The HMI 31 receives input of various data, instructions, and the like, and presents various data to the driver or the like.

An outline of data input achieved by the HMI 31 will be described. The HMI 31 includes an input device operated by a human to input data. The HMI 31 generates an input signal on the basis of data, an instruction, or the like input via the input device, and supplies the generated input signal to each unit of the vehicle control system 11. The HMI 31 includes, as the input device, operating elements such as a touch panel, a button, a switch, and a lever. In addition, the HMI 31 may further include an input device through which information is allowed to be input by a method other than a manual operation, such as voices and gestures. Furthermore, for example, the HMI 31 may use, as the input device, a remote controller using infrared light or radio waves, an externally connected device such as a mobile device and a wearable device handling operations of the vehicle control system 11.

An outline of data presentation achieved by the HMI 31 will be described. The HMI 31 generates visual information, auditory information, and tactile information offered for an occupant or the outside of the vehicle. Moreover, the HMI 31 performs output control for controlling output of the respective generated items of information, output contents, an output timing, an output method, and the like. For example, as the visual information, the HMI 31 generates and outputs information indicated by images or light, such as an operation screen, display of a state of the vehicle 1, display of warning, and a monitoring image indicating a situation around the vehicle 1. Moreover, as the auditory information, the HMI 31 generates and outputs information indicated by sounds, such as voice guidance, a warning sound, and a warning message. Furthermore, as the tactile information, the HMI 31 generates and outputs information given to a haptic sense of the occupant by force, vibration, movement, or the like.

Examples adoptable as an output device for outputting the visual information from the HMI 31 include a display device which displays an image by itself to present visual information, or a projector device which projects an image to present visual information. Note that the display device may be a device for displaying visual information within a visual field of the occupant, such as a head-up display, a transmission type display, and a wearable device having an AR (Augmented Reality) function, instead of a display device having an ordinary display. Moreover, the HMI 31 can use, as the output device for outputting visual information, a display device included in a navigation device, an instrument panel, a CMS (Camera Monitoring System), an electronic mirror, a lamp, or other devices provided on the vehicle 1.

Examples adoptable as the output device for outputting the auditory information from the HMI 31 include an audio speaker, a headphone, and an earphone.

Examples adoptable as the output device for outputting the tactile information from the HMI 31 include a haptics element to which a haptics technology is applied. For example, the haptics element is provided at a portion in contact with the occupant of the vehicle 1, such as a steering wheel and a seat.

The vehicle control unit 32 controls respective units of the vehicle 1. The vehicle control unit 32 includes the steering control unit 81, the brake control unit 82, the drive control unit 83, a body system control unit 84, a light control unit 85, and a horn control unit 86.

The steering control unit 81 achieves detection, control, and the like of a state of a steering system of the vehicle 1. For example, the steering system includes a steering mechanism equipped with the steering wheel and the like, and electric power steering. For example, the steering control unit 81 includes a steering ECU for controlling the steering system, and an actuator for driving the steering system.

The brake control unit 82 achieves detection, control, and the like of a state of a brake system of the vehicle 1. For example, the brake system includes a brake mechanism equipped with a brake pedal and the like, an ABS (Antilock Brake System), and a regenerative brake mechanism. For example, the brake control unit 82 includes a brake ECU for controlling the brake system, and an actuator for driving the brake system.

The drive control unit 83 achieves detection, control, and the like of a state of a drive system of the vehicle 1. For example, the drive system includes an accelerator pedal, a driving force generation device for generating driving force for an internal combustion engine, a driving motor, or the like, and a driving force transmission mechanism for transmitting driving force to wheels. For example, the drive control unit 83 includes a drive ECU for controlling the drive system, and an actuator for driving the drive system.

The body system control unit 84 achieves detection, control, and the like of a state of a body system of the vehicle 1. For example, the body system includes a keyless entry system, a smart key system, an automatic window device, electrically operated seats, an air conditioner, airbags, seat belts, and a gear shift. For example, the body system control unit 84 includes a body system ECU for controlling the body system, and an actuator for driving the body system.

The light control unit 85 achieves detection, control, and the like of states of various lights of the vehicle 1. Examples assumed to be designated as a light corresponding to a control target include headlights, tail lights, fog lights, turn signals, brake lights, projection, and a display of a bumper. The light control unit 85 includes a light ECU for controlling lights, and an actuator for driving lights.

The horn control unit 86 achieves detection, control, and the like of a state of a car horn of the vehicle 1. For example, the horn control unit 86 includes a horn ECU for controlling the car horn, and an actuator for driving the car horn.

FIG. 19 is a diagram depicting an example of sensing areas of the cameras 51, the radars 52, the LiDARs 53, the ultrasonic sensors 54, and others included in the outside recognition sensor 25 depicted in FIG. 18. Note that FIG. 19 schematically illustrates a state of the vehicle 1 as viewed from above. The left end side corresponds to a front end (front) side of the vehicle 1, while the right end side corresponds to a rear end (rear) side of the vehicle 1.

A sensing area 101F and a sensing area 101B are examples of the sensing areas of the ultrasonic sensors 54. The sensing area 101F covers a periphery of the front end of the vehicle 1 by using a plurality of the ultrasonic sensors 54. The sensing area 101B covers a periphery of the rear end of the vehicle 1 by using a plurality of the ultrasonic sensors 54.

For example, sensing results obtained for the sensing area 101F and the sensing area 101B are available for parking assistance or the like of the vehicle 1.

Sensing areas 102F to 102B are examples of the sensing areas of the radars 52 for short distances and middle distances. The sensing area 102F covers an area up to a farther position than the sensing area 101F before the vehicle 1. The sensing area 102B covers an area up to a farther position than the sensing area 101B behind the vehicle 1. The sensing area 102L covers a periphery of a rear left side of the vehicle 1. The sensing area 102R covers a periphery of a rear right side of the vehicle 1.

For example, a sensing result obtained for the sensing area 102F is applied for detection of a vehicle, a pedestrian, or others present before the vehicle 1. For example, sensing results obtained for the sensing area 102B is applied for a rear collision prevention function of the vehicle 1. For example, sensing results obtained for the sensing area 102L and the sensing area 102R are available for detection of an object located in a blind area on the side of the vehicle 1.

Sensing areas 103F to 103B are examples of the sensing areas of the cameras 51. The sensing area 103F covers an area up to a farther position than the sensing area 102F before the vehicle 1. The sensing area 103B covers an area up to a farther position than the sensing area 102B behind the vehicle 1. The sensing area 103L covers a periphery of the left side of the vehicle 1. The sensing area 103R covers a periphery of the right side of the vehicle 1.

For example, a sensing result obtained for the sensing area 103F is available for recognition of a traffic light or a traffic sign, a lane departure prevention support system, and an automatic headlight control system. For example, a sensing result obtained for the sensing area 103B is available for parking assistance and a surround view system. For example, sensing results obtained for the sensing area 103L and the sensing area 103R are available for a surround view system.

A sensing area 104 is an example of the sensing area of the LiDAR 53. The sensing area 104 covers an area up to a farther position than the sensing area 103F before the vehicle 1. Meanwhile, the sensing area 104 has a narrower range in a left-right direction than the sensing area 103F.

For example, a sensing result obtained for the sensing area 104 is available for detection of an object such as a surrounding vehicle.

A sensing area 105 is an example of the sensing area of the radar 52 for long distances. The sensing area 105 covers an area up to a farther position than the sensing area 104 before the vehicle 1. Meanwhile, the sensing area 105 has a narrower range in the left-right direction than the sensing area 104.

For example, a sensing result obtained for the sensing area 105 is available for ACC (Adaptive Cruise Control), emergency braking, and collision avoidance.

Note that the sensing areas of the respective sensors included in the outside recognition sensor 25, i.e., the cameras 51, the radars 52, the LiDARs 53, and the ultrasonic sensors 54, may have various configurations other than the configuration depicted in FIG. 19. Specifically, the ultrasonic sensor 54 may also sense the sides of the vehicle 1, and the LiDAR 53 may sense the rear of the vehicle 1. Moreover, installation positions of the respective sensors are not limited to the respective examples described above. Furthermore, each of the sensors may be constituted by either a single sensor or a plurality of sensors.

In addition, for example, the present disclosure can also have following configurations.

(1)

A solid-state imaging device, including:
a pixel array unit that includes a plurality of pixels, wherein each pixel in the plurality of pixels is configured to generate charge by photoelectric conversion, in which
the plurality of pixels includes
a plurality of event pixels, wherein each pixel in the plurality of event pixels is configured to generate an event signal on the basis of a luminance change of incident light, and
a plurality of gradation pixels, wherein each pixel of the plurality of gradation pixels is configured to generate a luminance signal on the basis of an amount of incident light, and
a plurality of color filters, wherein at least one color filter of the plurality of color filters is disposed over each pixel of the plurality of pixels, wherein the color filters disposed over the event pixels are at least one of white color filters or cyan color filters, and wherein the color filters disposed over the gradation pixels are at least one of red color filters, green color filters, or blue color filters.
   (2)

The solid-state imaging device according to (1), in which an arrangement of the event pixels and the gradation pixels does not have 180 degree rotational symmetry.

(3)

The solid-state imaging device according to (1) or (2), in which
the color filters disposed over the event pixels include either white color filters or cyan color filters, and
the color filters disposed over the gradation pixels include red color filters, green color filters, and blue color filters.
   (4)

The solid-state imaging device according to any of (1) to (3), in which
the color filters disposed over the event pixels include both white filters and cyan filters, and
the color filters disposed over the gradation pixels include red color filters, green color filters, and blue color filters.
   (5)

The solid-state imaging device according to any of (1) to (4), in which an event pixel located adjacent to a gradation pixel having a blue color filter has a cyan color filter.

(6)

The solid-state imaging device according to any of (1) to (4), in which an event pixel located adjacent to a gradation pixel having a color filter in any color other than blue has a white color filter.

(7)

The solid-state imaging device according to (4), in which
each of the event pixels located in a central portion of the pixel array unit has a white color filter, and
each of the event pixels located in a peripheral portion of the pixel array unit has a cyan color filter.
   (8)

The solid-state imaging device according to any of (1) to (7), in which a ratio of a number of the event pixels to a total number of the event pixels and the gradation pixels included in the pixel array unit is 25% or smaller.

(9)

The solid-state imaging device according to 8, wherein the ration of the number of the event pixels to the total number of the event pixels and the gradation pixels included in the pixel array unit is 12.5% or smaller.

(10)

The solid-state imaging device according to any of (1) to (9), in which each of the event pixels includes an event-based vision sensor (EVS) pixel.

(11)

The solid-state imaging device according to any of (1) to (10), in which first light shielding walls are provided between the color filters of the plurality of pixels.

(12)

The solid-state imaging device according to (11), in which each of the first light shielding walls includes a low refractive index material structure or an air structure.

(13)

The solid-state imaging device according to (11) or (12), in which each of the first light shielding walls provided between the color filters of the gradation pixels and the color filters of adjacent event pixels has a thickness different from a thickness of each of the first light shielding walls provided between the color filters of the gradation pixels and the color filters of adjacent gradation pixels.

(14)

The solid-state imaging device according to (13), in which each of the first light shielding walls provided between the color filters of the gradation pixels each having a blue color filter and the color filters of the adjacent event pixels has a thickness larger than the thickness of each of the first light shielding walls provided between the color filters of the gradation pixels and the color filters of the adjacent gradation pixels.

(15)

The solid-state imaging device according to (13), in which each of the first light shielding walls provided between the color filters of the gradation pixels each having a color filter in any color other than blue and the color filters of the adjacent event pixels has a thickness smaller than the thickness of each of the first light shielding walls provided between the color filters of the gradation pixels and the color filters of the adjacent gradation pixels.

(16)

The solid-state imaging device according to any of (1) to (15), further comprising:
a plurality of on-chip lenses,
wherein one on-chip lens of the plurality of on-chip lenses is disposed over the color filter of each pixel of the plurality of pixels, and
wherein each on-chip lens collects incident light, and;
a plurality of second light shielding walls, wherein one second light shielding wall of the plurality of light shielding walls is disposed between each adjacent pair of on-chip lenses of the plurality of pixels.
   (17)

The solid-state imaging device according to any of (1) to (16), further including:
a plurality of waveguides, wherein one waveguide in the plurality of waveguides is provided on each of at least some color filters of the plurality of color filters, and wherein each wave guide constitutes an optical path for incident light.
   (18)

The solid-state imaging device according to (17), in which the waveguides are provided on the white color filters or the cyan color filters.

(19)

The solid-state imaging device according to any of (1) to (18), in which
each pixel of the plurality of pixels further includes a photodiode that is located within a semiconductor substrate below the color filter and performs photoelectric conversion, the solid-state imaging device further including:
third light shielding walls, wherein the third light shielding walls penetrate an interior of the semiconductor substrate and are provided between the photodiodes of the plurality of pixels.
   (20)

The solid-state imaging device according to (19), further including:
fourth light shielding walls, wherein the fourth light shielding walls are provided between the plurality of pixels within an insulation film below the semiconductor substrate.
   (21)

The solid-state imaging device according to any of (1) to (20), wherein the pixels are disposed in subsets of 4×4 pixels, wherein each subset of 4×4 pixels includes gradation pixels around a perimeter of the subset and a 2×2 set of event pixels centered in the subset.

(22)

The solid-state imaging device according to any of (1) to (4), (6), (9)-(17), (19), or (20), wherein the pixels are disposed in subsets of 4×4 pixels, wherein, for each subset of 4×4 pixels:
a first row includes: first and second gradation pixels over which red color filters are disposed, and third and fourth gradation pixels over which green color filters are disposed;
a second row includes: first and second gradation pixels over which red color filters are disposed, a first event pixel, and a third gradation pixel over which a green color filter is disposed;
a third row includes: first and second gradation pixels over which green color filters are disposed, a first event pixel, and a third gradation pixel over which a blue color filter is disposed; and
a fourth row includes: first and second gradation pixels over which green color filters are disposed, and third and fourth gradation pixels over which blue color filters are disposed.
   (23)

The solid-state imaging device according to any of (1) to (19), wherein, for each pixel in the plurality of pixels, each event pixel is adjacent one other event pixel, and wherein each pair of adjacent event pixels has a color filter of a same type.

(24)

An electronic apparatus including:
an imaging apparatus, in which
the imaging apparatus includes a pixel array unit that includes a plurality of pixels, wherein each pixel of the plurality of pixels is configured to generate charge by photoelectric conversion,
wherein the plurality of pixels includes
a plurality of event pixels, wherein each pixel of the plurality of event pixels is configured to generate an event signal on the basis of a luminance change of incident light, and
a plurality of gradation pixels, wherein each pixel of the plurality of gradation pixels is configured to generate a luminance signal on the basis of an amount of incident light, and
a plurality of color filters, wherein at least one color filter of the plurality of color filters is disposed over each pixel of the plurality of pixels, wherein the color filters disposed over the event pixels are at least one of white color filters or cyan color filters, and wherein the color filters disposed over the gradation pixels are at least one of qqqqqqred color filters, green color filters, or blue color filters.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1: Vehicle
2: Drive unit
3: Arbiter
4: Event signal processing unit
5: Luminance signal processing unit
6: Central portion of the pixel array unit
7: Peripheral portion of the pixel array unit
9: Pixel
9a: Gradation pixel
9b: Event pixel
10: Pixel array unit
11: Vehicle control system
21: Vehicle control ECU
22: Communication unit
23: Map information accumulation unit
24: Position information acquisition unit
25: Outside recognition sensor
26: In-vehicle sensor
27: Vehicle sensor
28: Storage unit
29: Traveling assistance and autonomous driving control unit
30: DMS
31: HMI
32: Vehicle control unit
41: Communication network
51: Camera
52: Radar
53: LiDAR
54: Ultrasonic sensor
61: Analysis unit
62: Behavior planning unit
63: Action control unit
71: Self-position estimation unit
72: Sensor fusion unit
73: Recognition unit
81: Steering control unit
82: Brake control unit
83: Drive control unit
84: Body system control unit
85: Light control unit
86: Horn control unit
88: Semiconductor substrate
89: Insulation film
90: On-chip lens
91: Interpixel light shielding film
92: Photodiode
93: First light shielding wall
93′: First light shielding wall
93″: First light shielding wall
93″′: First light shielding wall
94: Second light shielding wall
95: Waveguide
96: Element separation insulation film
97: Third light shielding wall
98: Fourth light shielding wall
99: Transfer transistor
100: Imaging apparatus
110: Imaging lens
120: Data processing unit
130: Control unit
140: Recording unit
150: Data generation unit
200: Solid-state imaging device
R: Red
G: Green
B: Blue
W: White
W′: White
C: Cyan

What is claimed is:

1. A solid-state imaging device, comprising:
a pixel array unit that includes a plurality of pixels, wherein each pixel in the plurality of pixels is configured to generate charge by photoelectric conversion, wherein
the plurality of pixels includes:
a plurality of event pixels, wherein each pixel of the plurality of event pixels is configured to generate an event signal on a basis of a luminance change of incident light; and
a plurality of gradation pixels, wherein each pixel of the plurality of gradation pixels is configured to generate a luminance signal on a basis of an amount of incident light; and
a plurality of color filters, wherein at least one color filter of the plurality of color filters is disposed over each pixel of the plurality of pixels, wherein the color filters disposed over the event pixels are at least one of white color filters or cyan color filters, and wherein the color filters disposed over the gradation pixels are at least one of red color filters, green color filters, or blue color filters.

2. The solid-state imaging device according to claim 1, wherein an arrangement of the event pixels and the gradation pixels does not have 180 degree rotational symmetry.

3. The solid-state imaging device according to claim 1,
wherein the color filters disposed over the event pixels include either white color filters or cyan color filters, and
wherein the color filters disposed over the gradation pixels include red color filters, green color filters, and blue color filters.

4. The solid-state imaging device according to claim 1,
wherein the color filters disposed over the event pixels include both white color filters and cyan color filters, and
wherein the color filters disposed over the gradation pixels include red color filters, green color filters, and blue color filters.

5. The solid-state imaging device according to claim 4, wherein an event pixel located adjacent to a gradation pixel having a blue color filter has a cyan color filter.

6. The solid-state imaging device according to claim 4, wherein an event pixel located adjacent to a gradation pixel having a color filter in any color other than blue has a white color filter.

7. The solid-state imaging device according to claim 4,
wherein each of the event pixels located in a central portion of the pixel array unit has a white color filter, and
wherein each of the event pixels located in a peripheral portion of the pixel array unit has a cyan color filter.

8. The solid-state imaging device according to claim 1, wherein a ratio of a number of the event pixels to a total number of the event pixels and the gradation pixels included in the pixel array unit is 25% or smaller.

9. The solid-state imaging device according to claim 8, wherein the ration of the number of the event pixels to the total number of the event pixels and the gradation pixels included in the pixel array unit is 12.5% or smaller.

10. The solid-state imaging device according to claim 1, wherein each of the event pixels includes an event-based vision sensor (EVS) pixel.

11. The solid-state imaging device according to claim 1, wherein first light shielding walls are provided between the color filters of the plurality of pixels.

12. The solid-state imaging device according to claim 11, wherein each of the first light shielding walls includes a low refractive index material structure or an air structure.

13. The solid-state imaging device according to claim 11, wherein each of the first light shielding walls provided between the color filters of the gradation pixels and the color filters of adjacent event pixels has a thickness different from a thickness of each of the first light shielding walls provided between the color filters of the gradation pixels and the color filters of adjacent gradation pixels.

14. The solid-state imaging device according to claim 13, wherein each of the first light shielding walls provided between the color filters of the gradation pixels each having a blue color filter and the color filters of the adjacent event pixels has a thickness larger than the thickness of each of the first light shielding walls provided between the color filters of the gradation pixels and the color filters of the adjacent gradation pixels.

15. The solid-state imaging device according to claim 13, wherein each of the first light shielding walls provided between the color filters of the gradation pixels each having a color filter in any color other than blue and the color filters of the adjacent event pixels has a thickness smaller than the thickness of each of the first light shielding walls provided between the color filters of the gradation pixels and the color filters of the adjacent gradation pixels.

16. The solid-state imaging device according to claim 1, further comprising:
a plurality of on-chip lenses,
wherein one on-chip lens of the plurality of on-chip lenses is disposed over the color filter of each pixel of the plurality of pixels, and
wherein each on-chip lens collects incident light, and;
a plurality of second light shielding walls, wherein one second light shielding wall of the plurality of light shielding walls is disposed between each adjacent pair of on-chip lenses of the plurality of pixels.

17. The solid-state imaging device according to claim 16, further comprising:
a plurality of waveguides, wherein one waveguide in the plurality of waveguides is provided on each of at least some color filters of the plurality of color filters, and wherein each wave guide constitutes an optical path for incident light.

18. The solid-state imaging device according to claim 17, wherein the waveguides are provided on the white color filters or the cyan color filters.

19. The solid-state imaging device according to claim 1, wherein
each pixel of the plurality of pixels further includes a photodiode that is located within a semiconductor substrate below the color filter and performs photoelectric conversion, the solid-state imaging device further comprising:
third light shielding walls, wherein the third light shielding walls penetrate an interior of the semiconductor substrate and are provided between the photodiodes of the plurality of pixels.

20. The solid-state imaging device according to claim 19, further comprising:
fourth light shielding walls, wherein the fourth light shielding walls are provided between the plurality of pixels within an insulation film below the semiconductor substrate.

21. The solid-state imaging device according to claim 1, wherein the pixels are disposed in subsets of 4×4 pixels, wherein, for each subset of 4×4 pixels:
a first row includes: first and second gradation pixels over which red color filters are disposed, and third and fourth gradation pixels over which green color filters are disposed;
a second row includes: a first gradation pixel over which a red color filter is disposed, a first event pixel, a second event pixel, and a second gradation pixel over which a green color filter is disposed;
a third row includes: a first gradation pixel over which a green color filter is disposed, a first event pixel, a second event pixel, and a second gradation pixel over which a blue color filter is disposed; and
a fourth row includes: first and second gradation pixels over which green color filters are disposed and third and fourth gradation pixels over which blue color filters are disposed.

22. The solid-state imaging device according to claim 1, wherein the pixels are disposed in subsets of 4×4 pixels, wherein, for each subset of 4×4 pixels:
a first row includes: first and second gradation pixels over which red color filters are disposed, and third and fourth gradation pixels over which green color filters are disposed;
a second row includes: first and second gradation pixels over which red color filters are disposed, a first event pixel, and a third gradation pixel over which a green color filter is disposed;
a third row includes: first and second gradation pixels over which green color filters are disposed, a first event pixel, and a third gradation pixel over which a blue color filter is disposed; and
a fourth row includes: first and second gradation pixels over which green color filters are disposed, and third and fourth gradation pixels over which blue color filters are disposed.

23. The solid-state imaging device according to claim 1, wherein, for each pixel in the plurality of pixels, each event pixel is adjacent one other event pixel, and wherein each pair of adjacent event pixels has a color filter of a same type.

24. An electronic apparatus, comprising:
an imaging apparatus,
wherein the imaging apparatus includes a pixel array unit that includes a plurality of pixels, wherein each pixel in the plurality of pixels is configured to generate charge by photoelectric conversion,
wherein the plurality of pixels includes:
a plurality of event pixels, wherein each pixel of the plurality of event pixels is configured to generate an event signal on a basis of a luminance change of incident light; and
a plurality of gradation pixels, wherein each pixel of the plurality of gradation pixels is configured to generate a luminance signal on a basis of an amount of incident light; and
a plurality of color filters, wherein at least one color filter of the plurality of color filters is disposed over each pixel of the plurality of pixels, wherein the color filters disposed over the event pixels are at least one of white color filters or cyan color filters, and wherein the color filters disposed over the gradation pixels are at least one of red color filters, green color filters, or blue color filters.
